(19) United States
(12) Patent Application Publication
(10) Pub. No.: US 2026/0036790 A1
(43) Pub. Date: Feb. 5, 2026

(54) OPTICAL IMAGING LENS ASSEMBLY

(71) Applicant: ZHEJIANG SUNNY OPTICS CO., LTD., Yuyao City (CN)

(72) Inventors: Kairong LI, Yuyao City (CN); Shicheng BAO, Yuyao City (CN); Weifang LI, Yuyao City (CN); Yinfang JIN, Yuyao City (CN); Liefeng ZHAO, Yuyao City (CN)

(73) Assignee: ZHEJIANG SUNNY OPTICS CO., LTD., Yuyao City (CN)

(21) Appl. No.: 19/256,596

(22) Filed: Jul. 1, 2025

(30) Foreign Application Priority Data
Jul. 30, 2024 (CN) 202411034886.1

(51) Int. Cl. G02B 13/00; G02B 7/02; G02B 9/62; G02B 27/00

(52) U.S. Cl. CPC G02B 13/0045; G02B 7/021; G02B 9/62; G02B 27/0018

(57) ABSTRACT

The disclosure discloses an optical imaging lens assembly, including: a lens barrel, and a lens group and a support member group, which are accommodated in the lens barrel, wherein the lens group includes a first lens to a sixth lens, which are sequentially arranged from an object side to an image side along an optical axis; the first lens, a second lens, a fourth lens and a fifth lens have a positive refractive powers, and a third lens and the sixth lens have a negative refractive powers; the support member group includes a fourth support member disposed between the fourth lens and the fifth lens and a fifth support member disposed between the fifth lens and the sixth lens; and the optical imaging lens assembly satisfies: 3.8<T56/T45<6.8, 1.7<EP45/T45<4.5, and 1.6<f5/(D5s−d5s)<2.8.

### CROSS-REFERENCE TO RELATED APPLICATION

The present invention claims the priority to Chinese Patent Application No. 202411034886.1 filed with the Chinese Patent Office on Jul. 30, 2024, the entire contents of each of which are incorporated herein by reference for all purposes.

### TECHNICAL FIELD

The disclosure relates to the field of optical devices, and particularly relates to an optical imaging lens assembly.

### BACKGROUND

In recent years, with increasing changes in consumption demands, the requirements for optical imaging lens assembly have become increasingly complex and diverse. The performance of the optical imaging lens assembly varies in different application scenarios.

Six-piece optical imaging lens assembly have become the mainstream and have been widely applied in the fields of mobile phones, VR helmets, smart watches, smart glasses, and the like. A rear lens has a greater impact on the overall imaging of the six-piece optical imaging lens assembly, for example, a fifth lens and a sixth lens are more sensitive, and when the fifth lens and the sixth lens and support members in the vicinity of the fifth lens and the sixth lens are not disposed reasonably, the optical imaging lens assembly has the problem of stray light.

### SUMMARY

Some embodiments of the disclosure provide an optical imaging lens assembly capable of at least solving or partially solving at least one problem existing in the related art or other problems.

One embodiment of the disclosure provides an optical imaging lens assembly, including a lens barrel, and a lens group and a support member group, which are accommodated in the lens barrel, wherein the lens group sequentially includes, from an object side to an image side along an optical axis: a first lens having a positive refractive power, a second lens having a positive refractive power, a third lens having a negative refractive power, a fourth lens having a positive refractive power, a fifth lens having a positive refractive power, and a sixth lens having a negative refractive power; the support member group includes a fourth support member and a fifth support member, the fourth support member is disposed between the fourth lens and the fifth lens and is in contact with an image-side surface of the fourth lens, and the fifth support member is disposed between the fifth lens and the sixth lens and is in contact with an image-side surface of the fifth lens; and the optical imaging lens assembly satisfies: 3.8<T56/T45<6.8, 1.7<EP45/T45<4.5, and 1.6<f5/(D5s−d5s)<2.8,wherein T45 is a spacing distance between the fourth lens and the fifth lens on the optical axis, T56 is a spacing distance between the fifth lens and the sixth lens on the optical axis, EP45 is a distance between the fourth support member and the fifth support member on the optical axis, f5 is an effective focal length of the fifth lens, D5s is an outer diameter of an object-side surface of the fifth support member, and d5s is an inner diameter of the object-side surface of the fifth support member.

Another embodiment of the disclosure provides an optical imaging lens assembly, including a lens barrel, and a lens group and a support member group, which are accommodated in the lens barrel, wherein the lens group includes a first lens, a second lens, a third lens, a fourth lens, a fifth lens and a sixth lens, which are sequentially arranged from an object side to an image side along an optical axis; the support member group includes a fifth support member, and the fifth support member is disposed between the fifth lens and the sixth lens and is in contact with an image-side surface of the fifth lens; a spacing distance between the fifth lens and the sixth lens on the optical axis is greater than a spacing distance between any two adjacent lenses among the first lens to the fifth lens on the optical axis; and an outer diameter D5m of an image-side surface of the fifth support member, an inner diameter d5m of the image-side surface of the fifth support member, and a spacing distance T56 between the fifth lens and the sixth lens on the optical axis satisfy: 1.8<(D5m−d5m)/T56<2.8.

Another embodiment of the disclosure provides an optical imaging lens assembly, including a lens barrel, and a lens group and a support member group, which are accommodated in the lens barrel, wherein the lens group includes a first lens, a second lens, a third lens, a fourth lens, a fifth lens and a sixth lens, which are sequentially arranged from an object side to an image side along an optical axis; the support member group includes a fifth support member, and the fifth support member is disposed between the fifth lens and the sixth lens and is in contact with an image-side surface of the fifth lens; and an inner diameter d5m of an image-side surface of the fifth support member, an effective focal length f6 of the sixth lens, and a refractive index N6 of the sixth lens satisfy: −2.7 <d5m/f6*N6<−1.8.

According to an exemplary embodiment of the disclosure, an inner diameter d4m of an image-side surface of the fourth support member, the inner diameter d5s of an object-side surface of the fifth support member, a radius of curvature R9 of an object-side surface of the fifth lens, and a radius of curvature R10 of the image-side surface of the fifth lens satisfy: −10.3<R9/d4m+R10/d5s<−0.6.

According to an exemplary embodiment of the disclosure, a maximum thickness CP5 of the fifth support member, the spacing distance T56 between the fifth lens and the sixth lens on the optical axis, and a distance SAG61 from an intersection point of an object-side surface of the sixth lens and the optical axis to an effective radius vertex of the object-side surface of the sixth lens on the optical axis satisfy: −1.3<SAG61/(CP5+T56)<−0.7.

According to an exemplary embodiment of the disclosure, an entrance pupil diameter EPD of the optical imaging lens assembly, an inner diameter d0s of an object-side end surface of the lens barrel, and an outer diameter D0m of an image-side end surface of the lens barrel satisfy: 0.95<(D0m−d0s)/EPD<1.2.

According to an exemplary embodiment of the disclosure, the support member group further includes a first support member, and the first support member is disposed between the first lens and the second lens and is in contact with an image-side surface of the first lens; and a spacing distance T12 between the first lens and the second lens on the optical axis and a maximum thickness CP1 of the first support member satisfy: 1.85<T12/CP1<4.4.

According to an exemplary embodiment of the disclosure, the support member group further includes a first support member, and the first support member is disposed between the first lens and the second lens and is in contact with an image-side surface of the first lens; and a center thickness CT1 of the first lens on the optical axis, a center thickness CT2 of the second lens on the optical axis, and a distance EP01 between an object-side end surface of the lens barrel and an object-side surface of the first support member on the optical axis satisfy: 1.6<CT2/(EP01-CT1)<2.9.

According to an exemplary embodiment of the disclosure, the support member group further includes a second support member, and the second support member is disposed between the second lens and the third lens and is in contact with an image-side surface of the second lens; a radius of curvature R3 of an object-side surface of the second lens and a radius of curvature R4 of the image-side surface of the second lens satisfy: −2.6 <R3/R4<0; a radius of curvature R5 of an object-side surface of the third lens and a radius of curvature R6 of an image-side surface of the third lens satisfy: 1.4<R5/R6<1.9; and a spacing distance T23 between the second lens and the third lens on the optical axis and a maximum thickness CP2 of the second support member satisfy: 0.3<T23/CP2<2.5.

According to an exemplary embodiment of the disclosure, the support member group further includes a first support member and a second support member, the first support member is disposed between the first lens and the second lens and is in contact with an image-side surface of the first lens, and the second support member is disposed between the second lens and the third lens and is in contact with an image-side surface of the second lens; and a combined focal length f12 of the first lens and the second lens, an outer diameter D1m of an image-side surface of the first support member, and an inner diameter d2s of an object-side surface of the second support member satisfy: 1.9<f12/(D1m−d2s)<3.0.

According to an exemplary embodiment of the disclosure, the support member group further includes a first support member and a second support member, the first support member is disposed between the first lens and the second lens and is in contact with an image-side surface of the first lens, and the second support member is disposed between the second lens and the third lens and is in contact with an image-side surface of the second lens; and a center thickness CT2 of the second lens on the optical axis and a distance EP12 between the first support member and the second support member on the optical axis satisfy: 1<CT2/EP12<1.9.

According to an exemplary embodiment of the disclosure, the support member group further includes a third support member, and the third support member is disposed between the third lens and the fourth lens and is in contact with an image-side surface of the third lens; and a spacing distance T34 between the third lens and the fourth lens on the optical axis, a center thickness CT4 of the fourth lens on the optical axis, and a distance EP34 between the third support member and the fourth support member on the optical axis satisfy: 1.5<(T34+CT4)/EP34<3.8.

According to an exemplary embodiment of the disclosure, the support member group further includes a second support member and a third support member, the second support member is disposed between the second lens and the third lens and is in contact with an image-side surface of the second lens, and the third support member is disposed between the third lens and the fourth lens and is in contact with an image-side surface of the third lens; a center thickness CT2 of the second lens on the optical axis and a center thickness CT3 of the third lens on the optical axis satisfy: 1.7<CT2/CT3<3.2; and a distance EP23 between the second support member and the third support member on the optical axis and a spacing distance T34 between the third lens and the fourth lens on the optical axis satisfy: 0.9<EP23/T34<1.6.

According to an exemplary embodiment of the disclosure, the support member group further includes a second support member and a third support member, and the second support member is disposed between the second lens and the third lens and is in contact with an image-side surface of the second lens, and the third support member is disposed between the third lens and the fourth lens and is in contact with an image-side surface of the third lens; an effective focal length f2 of the second lens and an outer diameter D2s of an object-side surface of the second support member satisfy: 1.0<f2/D2s<3.2; and an effective focal length f3 of the third lens and an inner diameter d3s of an object-side surface of the third support member satisfy: −2.6<f3/d3s<−1.5.

According to an exemplary embodiment of the disclosure, the support member group further includes a third support member and a third auxiliary support member, the third support member is disposed between the third lens and the fourth lens and is in contact with an image-side surface of the third lens, and the third auxiliary support member is disposed on an image-side surface of the third support member and is in contact with the image-side surface of the third support member; and the spacing distance T34 between the third lens and the fourth lens on the optical axis, a maximum thickness CP3 of the third support member, and a maximum thickness CP3b of the third auxiliary support member satisfy: 0<(CP3b+CP3)/T34<0.7.

According to an exemplary embodiment of the disclosure, the support member group further includes a fourth auxiliary support member, and the fourth auxiliary support member is disposed on the image-side surface of the fourth support member and is in contact with an image-side surface of the fourth support member.

The optical imaging lens assembly provided in the disclosure uses six lenses, and satisfies “3.8<T56/T45<6.8”, which results in an excessively large ratio of a vector height of the sixth lens to the center thickness, so that an effective diameter portion of the sixth lens is prone to the risk of weld marks during molding, thus affecting the imaging quality of the optical imaging lens assembly. By means of controlling “1.7 <EP45/T45<4.5” and “1.6 <f5/(D5s−d5s)<2.8”, it is conducive to reasonably allocating edge thicknesses of the fifth lens and the sixth lens, so that the vector height of the object-side surface of the sixth lens is located within a proper range, thereby ensuring that the ratio of the vector height of the object-side surface of the sixth lens to the center thickness is not too large, and reducing the risk of weld marks of the effective diameter portion of the sixth lens during molding; and meanwhile, the inner and outer diameters of the object-side surface of the fifth support member may also be limited, so that the fifth support member is able to block stray light generated by a front end in a case where the assembly stability of the optical imaging lens assembly is satisfied.

### BRIEF DESCRIPTION OF THE DRAWINGS

Other features, objectives and advantages of the disclosure will become more apparent upon reading the detailed description of non-limiting embodiments with reference to the following drawings:

FIG. 1 shows a structure arrangement diagram of an optical imaging lens assembly and a schematic diagram of some parameters according to the disclosure;

FIG. 2A shows a schematic structural diagram of an optical imaging lens assembly according to Embodiment 1 of the disclosure;

FIG. 2B shows a schematic structural diagram of an optical imaging lens assembly according to Embodiment 2 of the disclosure;

FIG. 2C shows a schematic structural diagram of an optical imaging lens assembly according to Embodiment 3 of the disclosure;

FIG. 3A to FIG. 3D respectively show a longitudinal aberration curve, an astigmatism curve, a distortion curve and a lateral color curve of the optical imaging lens assembly according to Embodiment 1 to Embodiment 3 of the disclosure;

FIG. 4A shows a schematic structural diagram of an optical imaging lens assembly according to Embodiment 4 of the disclosure;

FIG. 4B shows a schematic structural diagram of an optical imaging lens assembly according to Embodiment 5 of the disclosure;

FIG. 4C shows a schematic structural diagram of an optical imaging lens assembly according to Embodiment 6 of the disclosure;

FIG. 5A to FIG. 5D respectively show a longitudinal aberration curve, an astigmatism curve, a distortion curve and a lateral color curve of the optical imaging lens assembly according to Embodiment 4 to Embodiment 6 of the disclosure;

FIG. 6A shows a schematic structural diagram of an optical imaging lens assembly according to Embodiment 7 of the disclosure;

FIG. 6B shows a schematic structural diagram of an optical imaging lens assembly according to Embodiment 8 of the disclosure;

FIG. 6C shows a schematic structural diagram of an optical imaging lens assembly according to Embodiment 9 of the disclosure;

FIG. 7A to FIG. 7D respectively show a longitudinal aberration curve, an astigmatism curve, a distortion curve and a lateral color curve of the optical imaging lens assembly according to Embodiment 7 to Embodiment 9 of the disclosure;

FIG. 8A and FIG. 8B respectively show a ray diagram and a light spot diagram on an imaging surface when an optical imaging lens assembly of the disclosure satisfies T56/T45=4.3, EP45/T45=4, and f5/(D5s−d5s)=2.2;

FIG. 9A and FIG. 9B respectively show another ray diagram and a light spot diagram on an imaging surface when an optical imaging lens assembly of the disclosure satisfies T56/T45=4.3, EP45/T45=4, and f5/(D5s−d5s)=−2.2;

FIG. 10A and FIG. 10B respectively show a ray diagram and a light spot diagram on an imaging surface when an optical imaging lens assembly of the disclosure satisfies T56/T45=4.3, EP45/T45=0.2, and f5/(D5s−d5s)=−15;

FIG. 11A and FIG. 11B respectively show a ray diagram and a light spot diagram on an imaging surface when an optical imaging lens assembly of the disclosure satisfies T56/T45=4.3, EP45/T45=15, and f5/(D5s−d5s)=6.

### DETAILED DESCRIPTION OF THE EMBODIMENTS

For a better understanding of the disclosure, various embodiment s of the disclosure will be described in more detail with reference to the drawings. It should be understood that these detailed descriptions are merely descriptions of exemplary embodiments of the disclosure, and are not intended to limit the scope of the disclosure in any way. Throughout the specification, the same reference signs refer to the same elements.

It should be noted that in the present specification, expressions such as first, second and third are only used to distinguish one feature from another feature, but do not indicate any limitation to the features. Therefore, without departing from the teachings of the disclosure, a first lens discussed below may also be referred to as a second lens or a third lens.

In the drawings, for ease of description, the thickness, size and shape of the lens have been slightly exaggerated. Specifically, the shape of a spherical surface or an aspheric surface shown in the drawings is shown by way of example. That is, the shape of the spherical surface or the aspheric surface is not limited to the shape of the spherical surface or the aspheric surface shown in the drawings. The drawings are merely examples and are not strictly drawn to scale.

Herein, a paraxial region refers to a region in the vicinity of an optical axis. If the surface of a lens is a convex surface and the position of the convex surface is not defined, it indicates that the surface of the lens is a convex surface at least in the paraxial region; and if the surface of the lens is a concave surface and the position of the concave surface is not defined, it indicates that the surface of the lens is a concave surface at least in the paraxial region. The surface of each lens closest to a photographed object is referred to as an object-side surface of the lens, and the surface of each lens closest to an imaging surface is referred to as an image-side surface of the lens.

It should also be understood that, the terms “include” and/or “have”, when used in the present specification, indicate the presence of stated features, elements and/or components, but do not preclude the presence or addition of one or more other features, elements, components and/or combinations thereof. In addition, when the implementations of the disclosure are described, “may” is used to indicate “one or more implementations of the disclosure”. Moreover, the term “exemplary” is intended to refer to an example or illustration.

Unless otherwise defined, all terms (including technical terms and scientific terms) used herein have the same meanings as commonly understood by those ordinary skilled in the art to which the disclosure belongs. It should also be understood that terms (e.g., terms defined in commonly used dictionaries) should be interpreted as having meanings consistent with those in the context of related art and will not be interpreted in an idealized or overly formal sense, unless expressly so defined herein.

It should be noted that, in the case of no conflict, embodiments in the disclosure and features in the embodiments may be combined with each other. The following embodiments only express several implementations of the disclosure, and the description thereof is relatively specific and detailed, but cannot be understood as limitations to the patent scope of the disclosure. It should be pointed out that, for those ordinary skilled in the art, several modifications and improvements may also be made without departing from the concept of the disclosure, and all these modifications and improvements fall within the protection scope of the disclosure, for example, a lens group, a lens barrel and a support member group in various embodiments of the disclosure may be arbitrarily combined, and it is not limited to that the lens group in one embodiment may only be combined with the lens barrel, the support member group and the like in the embodiment.

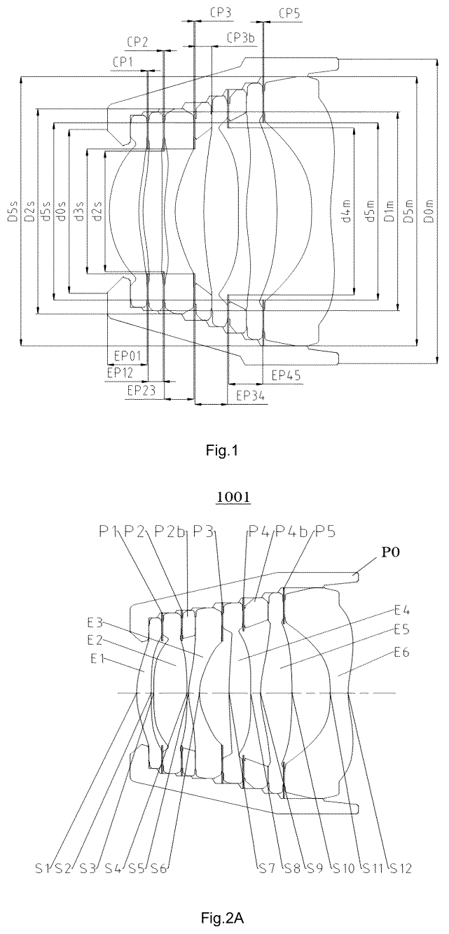

The disclosure will be described in detail below with reference to the drawings and in combination with the embodiments. FIG. 1 exemplarily shows a structure arrangement diagram of an optical imaging lens assembly and a schematic diagram of some parameters according to the disclosure, so as to better understand the disclosure. As shown in FIG. 1, d0s is an inner diameter of an object-side end surface of a lens barrel, d2s is an inner diameter of an object-side surface of a second support member, d3s is an inner diameter of an object-side surface of a third support member, d5s is an inner diameter of an object-side surface of a fifth support member, D2s is an outer diameter of the object-side surface of the second support member, D5s is an outer diameter of the object-side surface of the fifth support member, D0m is an outer diameter of an image-side end surface of the lens barrel, D1m is an outer diameter of an image-side surface of a first support member, D5m is an inner diameter of an image-side surface of the fifth support member, d4m is an inner diameter of an image-side surface of a fourth support member, d5m is an inner diameter of the image-side surface of the fifth support member, CP1 is a maximum thickness of the first support member, CP2 is a maximum thickness of the second support member, CP3 is a maximum thickness of the third support member, CP3b is a maximum thickness of a third auxiliary support member, CP5 is a maximum thickness of the fifth support member, EP01 is a distance between the object-side end surface of the lens barrel and an object-side surface of the first support member on an optical axis, EP12 is a distance between the first support member and the second support member on the optical axis, EP23 is a distance between the second support member and the third support member on the optical axis, EP34 is a distance between the third support member and the fourth support member on the optical axis, and EP45 is a distance between the fourth support member and the fifth support member on the optical axis.

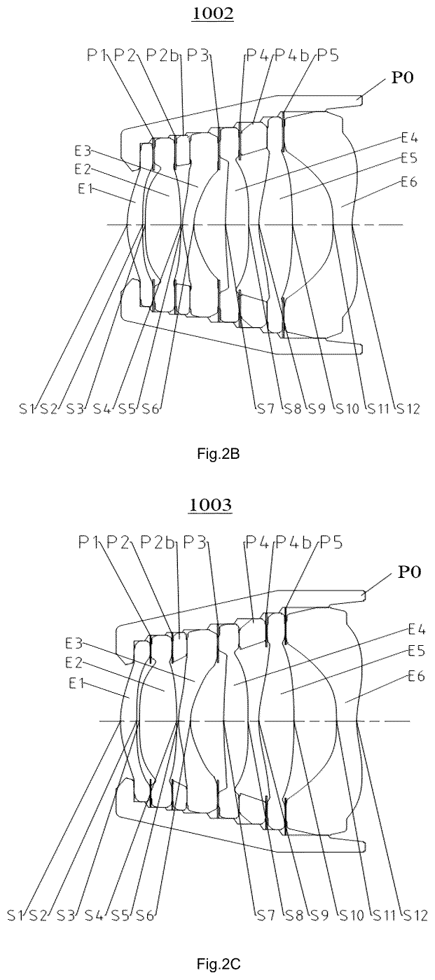

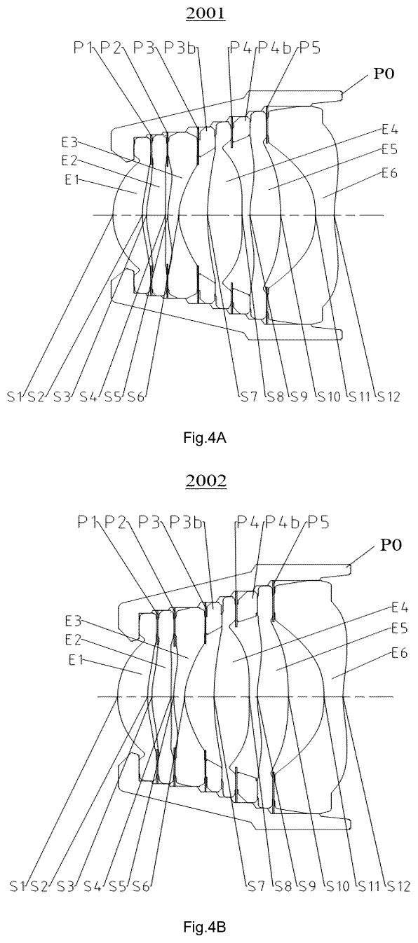

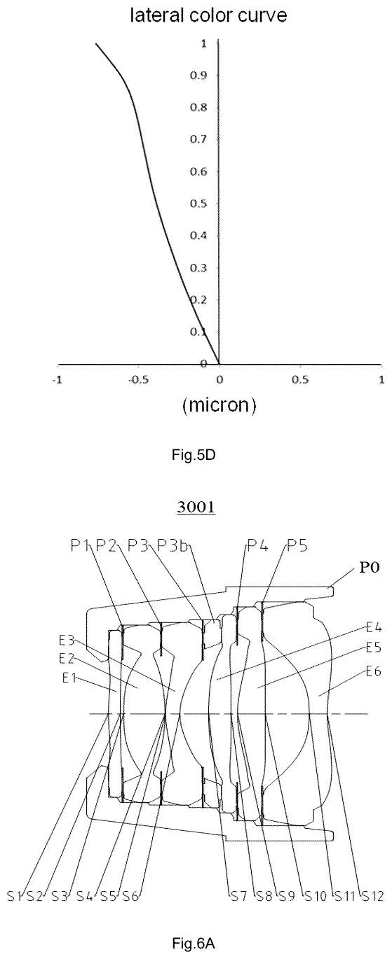

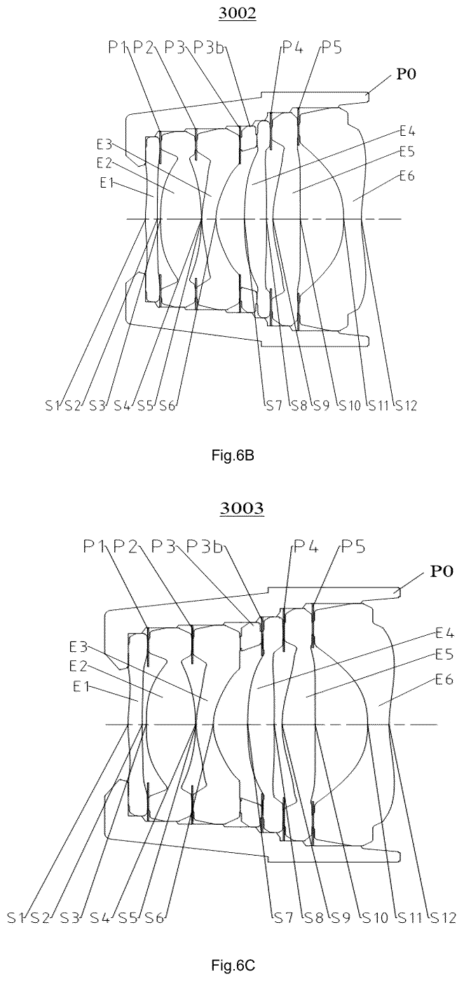

Referring to FIG. 2A, FIG. 2B, FIG. 2C, FIG. 4A, FIG. 4B, FIG. 4C, FIG. 6A, FIG. 6B and FIG. 6C, a first embodiment of the disclosure provides an optical imaging lens assembly. The optical imaging lens assembly may include a lens group, and the lens group may include a first lens, a second lens, a third lens, a fourth lens, a fifth lens and a sixth lens, which are sequentially arranged from an object side to an image side along an optical axis. Each lens at least has one object-side surface facing one side of a photographed object and an image-side surface facing one side of an imaging surface. Among the first lens to the sixth lens, there may be a spacing distance between any two adjacent lenses, and the spacing distance may be an air gap.

In an exemplary embodiment, the first lens may have a positive refractive power. The second lens may have a positive refractive power. The third lens may have a negative refractive power. The fourth lens may have a positive refractive power. The fifth lens may have a positive refractive power. The sixth lens may have a negative refractive power.

In an exemplary embodiment, the optical imaging lens assembly further includes a support member group, and the support member group may include at least one support member. It should be understood that the disclosure does not specifically limit the number of support members, any number of support members may be included between any two lenses, and the entire optical imaging lens assembly may also include any number of support members. The support members facilitate the optical imaging lens assembly to intercept redundant refraction and reflection light paths, reduce the generation of stray light and ghosts, and improve the imaging quality.

In an exemplary embodiment, the optical imaging lens assembly further includes a lens barrel. The lens group and the support member group are disposed in the lens barrel. The lens barrel includes an object-side end surface, an image-side end surface, an outer ring surface and an inner ring surface, wherein the end surface of the lens barrel closest to the object side is the object-side end surface of the lens barrel, and the end surface of the lens barrel closest to the image side is the image-side end surface of the lens barrel; and in a direction perpendicular to the optical axis, the surface of the lens barrel farthest from the optical axis is the outer ring surface, and the surface of the lens barrel closest to the optical axis is the inner ring surface, wherein the inner ring surface is stepped, that is, an inner diameter of the inner ring surface gradually decreases from the image-side end surface to the object-side end surface in a stepped manner, and correspondingly, an outer diameter of the outer ring surface presents a decrease trend from the image-side end surface to the object-side end surface.

In an exemplary embodiment, the optical imaging lens assembly may further include a diaphragm for limiting a light beam, the diaphragm is conducive to collecting rays entering the optical lens, reducing the maximum clear aperture of the optical lens, and reducing the assembly sensitivity of the system, so as to further improve the imaging quality of the optical lens. It should be noted that the diaphragm may be disposed at a position between any lenses or on one side according to actual needs, for example, the diaphragm is disposed on an object-side surface of the first lens.

In an exemplary embodiment, the support member group further includes a fourth support member and a fifth support member, the fourth support member may be disposed between the fourth lens and the fifth lens, an object-side surface of the fourth support member is at least partially in contact with an image-side surface of the fourth lens, the fifth support member may be disposed between the fifth lens and the sixth lens, and an object-side surface of the fifth support member is at least partially in contact with an image-side surface of the fifth lens. The optical imaging lens assembly satisfies: 3.8<T56/T45<6.8, 1.7<EP45/T45<4.5, and 1.6<f5/(D5s−d5s)<2.8, wherein T45 is a spacing distance between the fourth lens and the fifth lens on the optical axis, T56 is a spacing distance between the fifth lens and the sixth lens on the optical axis, EP45 is a distance between the fourth support member and the fifth support member on the optical axis, f5 is an effective focal length of the fifth lens, D5s is an outer diameter of the object-side surface of the fifth support member, and d5s is an inner diameter of the object-side surface of the fifth support member.

In a six-piece optical imaging lens assembly, generally, when the optical imaging lens assembly satisfies 3.8<T56/T45<6.8, it is likely to lead to an excessively large ratio of a vector height of the sixth lens to the center thickness, so that an effective diameter of the sixth lens is prone to the risk of weld marks during molding. In the disclosure, by means of reasonably configuring the refractive power of each lens and by means of disposing and adjusting the fourth support member and the fifth support member, the edge thicknesses of the fifth lens and the sixth lens are reasonably allocated, it is ensured that the ratio of the vector height of the sixth lens to the center thickness is not too large, and the risk of weld marks of the effective diameter of the sixth lens during molding is reduced; and by means of controlling the focal length of the fifth lens and the inner and outer diameters of the object-side surface of the fifth support member, stray light generated by a front-end lens mechanism is able to be blocked while the assembly stability of the lens is satisfied, thereby improving the final imaging quality of the lens.

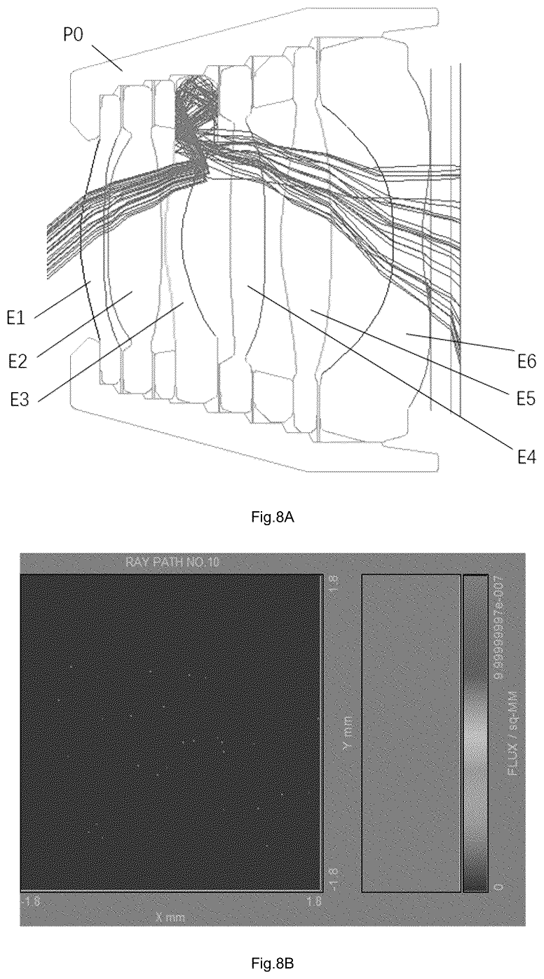

FIG. 8A and FIG. 8B respectively show a ray diagram and a light spot diagram on an imaging surface when an optical imaging lens assembly (lens 1) of the disclosure satisfies T56/T45=4.3, EP45/T45=4, and f5/(D5s−d5s)=2.2;

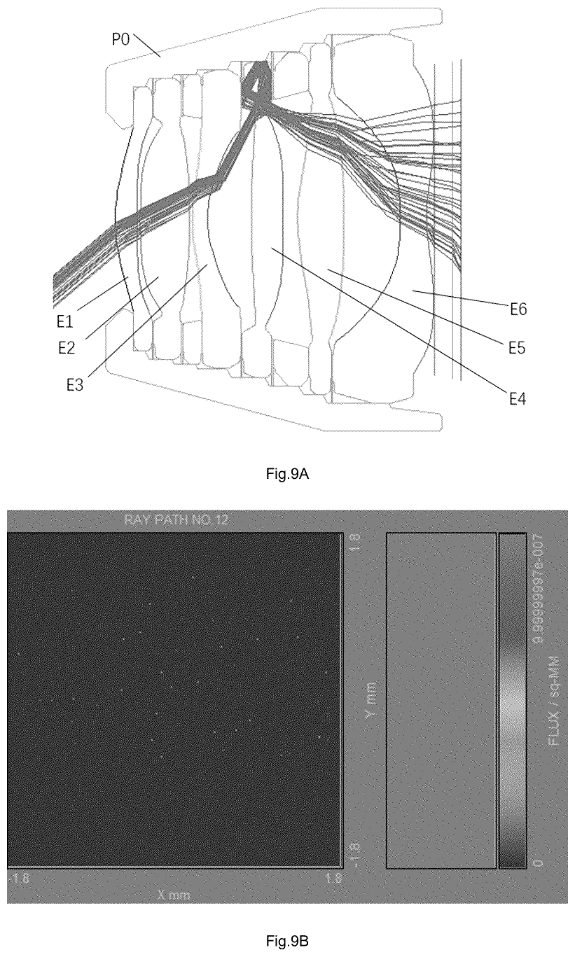

FIG. 9A and FIG. 9B respectively show another ray diagram and a light spot diagram on an imaging surface when the optical imaging lens assembly (lens 1) of the disclosure satisfies T56/T45=4.3, EP45/T45=4, and f5/(D5s−d5s)=−2.2;

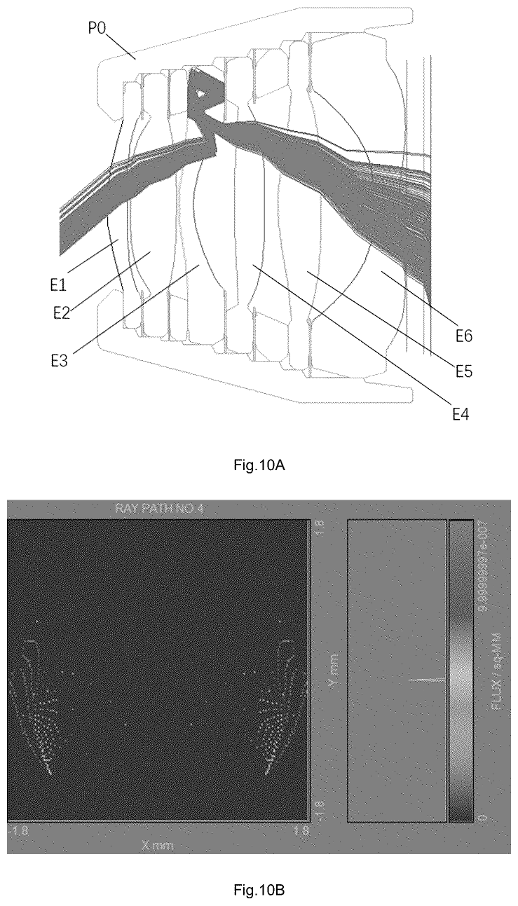

FIG. 10A and FIG. 10B respectively show a ray diagram and a light spot diagram on an imaging surface when an optical imaging lens assembly (lens 2) of the disclosure satisfies T56/T45=4.3, EP45/T45=0.2, and f5/(D5s−d5s)=−15; and

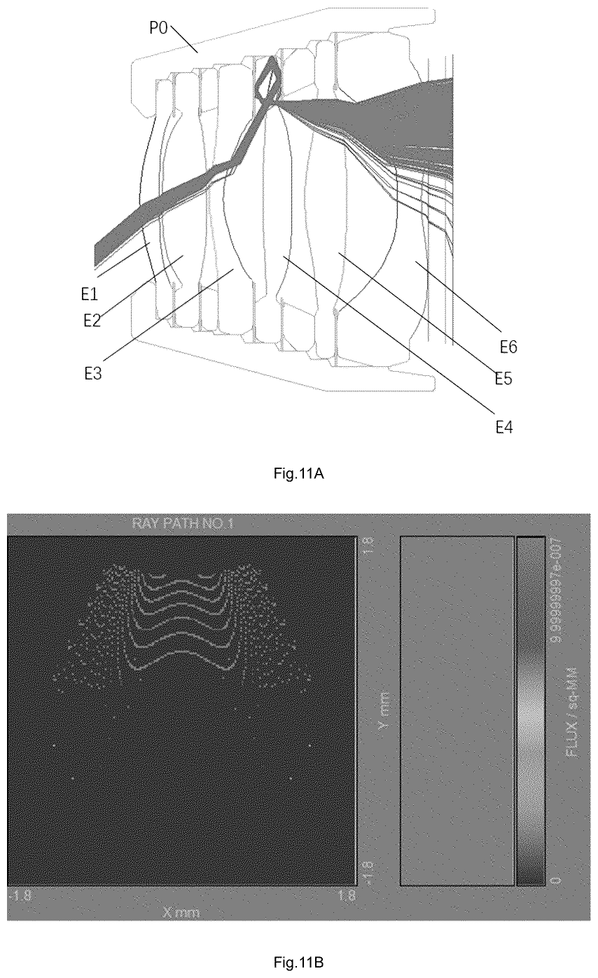

FIG. 11A and FIG. 11B respectively show a ray diagram and a light spot diagram on an imaging surface when an optical imaging lens assembly (lens 3) of the disclosure satisfies T56/T45=4.3, EP45/T45=15, and f5/(D5s−d5s)=6.

The value of T56/T45 of the lens 1 in FIG. 8A and FIG. 8B is 4.3, which is within the range of 3.8-6.8,such that the ratio of the vector height of the sixth lens to the center thickness is too large, and thus the effective diameter portion of the sixth lens is prone to the risk of weld marks during molding, thereby affecting the imaging quality of the optical imaging lens assembly; by means of controlling the ratios of EP45/T45 and f5/(D5s−d5s) to satisfy the ranges defined in the disclosure, it is conducive to reasonably allocating the edge thicknesses of the fifth lens and the sixth lens, so that the vector height of the object-side surface of the sixth lens is located within a proper range, thereby ensuring that the ratio of the vector height of the object-side surface of the sixth lens to the center thickness is not too large, and reducing the risk of weld marks of the effective diameter portion of the sixth lens during molding; and meanwhile, the inner and outer diameters of the object-side surface of the fifth support member may also be limited, so that stray light generated by the front end of the fifth support member is able to be blocked in a case where the assembly stability of the optical imaging lens assembly is satisfied, and it is able to be seen from FIG. 8B that stray light spots on the imaging surface are relatively dispersed and the number of light spots is very small.

The value of T56/T45 of the lens 1 in FIG. 9A and FIG. 9B is also within the range of 3.8-6.8, such that the ratio of the vector height of the sixth lens to the center thickness is too large, and thus the effective diameter portion of the sixth lens is prone to the risk of weld marks during molding, thereby affecting the imaging quality of the optical imaging lens assembly; and by means of controlling the ratio of EP45/T45 to satisfy the range defined in the disclosure, it is conducive to reasonably allocating the edge thicknesses of the fifth lens and the sixth lens, so that the vector height of the object-side surface of the sixth lens is located within a proper range, thereby ensuring that the ratio of the vector height of the object-side surface of the sixth lens to the center thickness is not too large, and reducing the risk of weld marks of the effective diameter portion of the sixth lens during molding. However, the ratio of f5/(D5s−d5s) does not satisfy the range defined in the disclosure, and it is able to be seen from FIG. 9 B that the number of stray light spots on the imaging surface is greater than that in FIG. 8B.

The value of T56/T45 of the lens 2 in FIG. 10A and FIG. 10B is also within the range of 3.8-6.8, such that the ratio of the vector height of the sixth lens to the center thickness is too large, and thus the effective diameter portion of the sixth lens is prone to the risk of weld marks during molding, thereby affecting the imaging quality of the optical imaging lens assembly; However, the ratios of EP45/T45 and f5/(D5s−d5s) do not satisfy the ranges defined in the disclosure, therefore not only does it fail to reduce the risk of weld marks of the effective diameter portion of the sixth lens during molding, but it is able to also be seen from FIG. 10B that the stray light spots on the imaging surface are concentrated on both sides and the number of light spots is relatively large.

The value of T56/T45 of the lens 3 in FIG. 11A and FIG. 11B is also within the range of 3.8-6.8, such that the ratio of the vector height of the sixth lens to the center thickness is too large, and thus the effective diameter portion of the sixth lens is prone to the risk of weld marks during molding, thereby affecting the imaging quality of the optical imaging lens assembly; However, the ratios of EP45/T45 and f5/(D5s−d5s) do not satisfy the ranges defined in the disclosure, therefore not only does it fail to reduce the risk of weld marks of the effective diameter portion of the sixth lens during molding, but it is able to also be seen from FIG. 11B that the stray light spots on the imaging surface are concentrated at the upper side of the middle, the number of light spots is relatively large, and the energy of the light spots is relatively large.

In an exemplary embodiment, the support member group further includes a fourth support member and a fifth support member, the fourth support member may be disposed between the fourth lens and the fifth lens, the object-side surface of the fourth support member is at least partially in contact with the image-side surface of the fourth lens, the fifth support member may be disposed between the fifth lens and the sixth lens, and the object-side surface of the fifth support member is at least partially in contact with the image-side surface of the fifth lens. An inner diameter d4m of the image-side surface of the fourth support member, the inner diameter d5s of the object-side surface of the fifth support member, a radius of curvature R9 of an object-side surface of the fifth lens, and a radius of curvature R10 of the image-side surface of the fifth lens satisfy: −10.3<R9/d4m +R10/d5s<−0.6. By means of controlling the above conditions, the shapes of the image-side surface and the object-side surface of the fifth lens are constrained, thereby facilitating the machining of the fifth lens; and by means of controlling the inner diameter of the object-side surface of the fifth support member and the inner diameter of the image-side surface of the fourth support member, it is conductive to blocking stray light.

In an exemplary embodiment, the support member group further includes a fifth support member, the fifth support member may be disposed between the fifth lens and the sixth lens, and the object-side surface of the fifth support member is at least partially in contact with the image-side surface of the fifth lens. A maximum thickness CP5 of the fifth support member, the spacing distance T56 between the fifth lens and the sixth lens on the optical axis, and a distance SAG61 from an intersection point of the object-side surface of the sixth lens and the optical axis to an effective radius vertex of the object-side surface of the sixth lens satisfy: −1.3<SAG61/(CP5+T56)<−0.7. By means of controlling the above parameters, the edge thicknesses of the fifth support member and the sixth lens are reasonably allocated, thereby ensuring a proper ratio of the thickness of the fifth support member to the thickness of the sixth lens, and thus facilitating the machining and molding of the fifth support member and the sixth lens.

In an exemplary embodiment, an entrance pupil diameter EPD of the optical imaging lens assembly, an inner diameter d0s of an object-side end surface of the lens barrel, and an outer diameter D0m of an image-side end surface of the lens barrel satisfy: 0.95<(D0m−d0s)/EPD<1.2; and a numerical aperture fno of the optical imaging lens assembly satisfies: 1.3<fno<1.5. By means of controlling the above conditions, on one hand, the volume of the lens barrel is able to be effectively controlled to realize lightness and thinness of the lens; and on the other hand, the numerical aperture and the entrance pupil diameter of the lens is able to be restrained to control the luminous flux of the lens, thereby improving the imaging quality.

In an exemplary embodiment, the support member group further includes a first support member disposed between the first lens and the second lens, and an object-side surface of the first support member is at least partially in contact with an image-side surface of the first lens. A spacing distance T12 between the first lens and the second lens on the optical axis and a maximum thickness CP1 of the first support member satisfy: 1.85<T12/CP1<4.4. By means of controlling the maximum thickness of the first support member and the spacing distance between the first lens and the second lens on the optical axis, the edge thicknesses of the first lens and the second lens are reasonably allocated, thereby ensuring that the first lens and the second lens have a proper molding thickness ratio, and thus facilitating the molding.

In an exemplary embodiment, the support member group further includes a first support member disposed between the first lens and the second lens, and the object-side surface of the first support member is at least partially in contact with the image-side surface of the first lens. A center thickness CT1 of the first lens on the optical axis, a center thickness CT2 of the second lens on the optical axis, and a distance EP01 between the object-side end surface of the lens barrel and the object-side surface of the first support member on the optical axis satisfy: 1.6<CT2/(EP01-CT1)<2.9. By means of controlling the above conditions, on the premise of ensuring the assembly stability of the lens, it is ensured that the first lens and the second lens have a proper thickness ratio, thereby facilitating the machining and molding of the first lens and the second lens.

In an exemplary embodiment, the support member group further includes a second support member disposed between the second lens and the third lens, and an object-side surface of the second support member is at least partially in contact with an image-side surface of the second lens. A radius of curvature R3 of an object-side surface of the second lens and a radius of curvature R4 of the image-side surface of the second lens satisfy: −2.6<R3/R4<0; a radius of curvature R5 of an object-side surface of the third lens and a radius of curvature R6 of an image-side surface of the third lens satisfy: 1.4<R5/R6<1.9; and a spacing distance T23 between the second lens and the third lens on the optical axis and a maximum thickness CP2 of the second support member satisfy: 0.3<T23/CP2<2.5. By means of controlling the radius of curvaturees of the object-side surfaces and the image-side surfaces of the second lens and the third lens, the overall shape uniformity of the second lens and the third lens is able to be effectively controlled, thereby facilitating the control over the trend of rays in the lens, and thus the final imaging is good; and by means of controlling the spacing distance between the second lens and the third lens on the optical axis and the maximum thickness of the second support member, a smaller thickness tolerance is obtained, thereby improving the structural sensitivity of the lens barrel, wherein a light shielding sheet may be selected as a support member.

In an exemplary embodiment, the support member group further includes a first support member and a second support member, the first support member is disposed between the first lens and the second lens, the object-side surface of the first support member is at least partially in contact with the image-side surface of the first lens, the second support member is disposed between the second lens and the third lens, and the object-side surface of the second support member is at least partially in contact with the image-side surface of the second lens. A combined focal length f12 of the first lens and the second lens, an outer diameter D1m of an image-side surface of the first support member and an inner diameter d2s of the object-side surface of the second support member satisfy: 1.9<f12/(D1m−d2s)<3.0. By means of controlling the combined focal length of the first lens and the second lens, it is conducive to controlling the direction of rays in the first lens and the second lens and reducing the sensitivity of the lens, and meanwhile it is helpful to block redundant rays, avoid stray light and improve the imaging quality of the lens.

In an exemplary embodiment, the support member group further includes a first support member and a second support member, the first support member is disposed between the first lens and the second lens, the object-side surface of the first support member is at least partially in contact with the image-side surface of the first lens, the second support member is disposed between the second lens and the third lens, and the object-side surface of the second support member is at least partially in contact with the image-side surface of the second lens. The center thickness CT2 of the second lens on the optical axis and a distance EP12 between the first support member and the second support member on the optical axis satisfy: 1<CT2/EP12<1.9. By means of controlling the distance between the first support member and the second support member on the optical axis and the center thickness of the second lens on the optical axis, the thickness ratio of the second lens is indirectly constrained, thereby facilitating the machining and molding of the second lens.

In an exemplary embodiment, the support member group further includes a third support member disposed between the third lens and the fourth lens, and an object-side surface of the third support member is at least partially in contact with the image-side surface of the third lens. A spacing distance T34 between the third lens and the fourth lens on the optical axis, a center thickness CT4 of the fourth lens on the optical axis, and a distance EP34 between the third support member and the fourth support member on the optical axis satisfy: 1.5<(T34+CT4)/EP34<3.8. By means of controlling the above parameters, the thicknesses of the third support member and the fourth support member, and the edge thicknesses of the third lens and the fourth lens are constrained, thereby ensuring that the third support member and the fourth support member have suitable molding thicknesses, and meanwhile also ensuring that the third lens and the fourth lens have proper thickness ratios, thus facilitating the molding.

In an exemplary embodiment, the support member group further includes a second support member and a third support member, the second support member is disposed between the second lens and the third lens, the object-side surface of the second support member is at least partially in contact with the image-side surface of the second lens, the third support member is disposed between the third lens and the fourth lens, and the object-side surface of the third support member is at least partially in contact with the image-side surface of the third lens. The center thickness CT2 of the second lens on the optical axis and a center thickness CT3 of the third lens on the optical axis satisfy: 1.7<CT2/CT3<3.2; and a distance EP23 between the second support member and the third support member on the optical axis and the spacing distance T34 between the third lens and the fourth lens on the optical axis satisfy: 0.9<EP23/T34<1.6. By means of controlling the above parameters, on one hand, the center thicknesses of the second lens and the third lens on the optical axis are directly constrained; and on the other hand, by means of controlling the spacing distance between the third lens and the fourth lens on the optical axis, and the distance between the second support member and the third support member on the optical axis, it is indirectly restrained that the vector height of the third lens is not too large, thereby improving the machinability of the second lens and the third lens.

In an exemplary embodiment, the support member group further includes a second support member and a third support member, the second support member is disposed between the second lens and the third lens, the object-side surface of the second support member is at least partially in contact with the image-side surface of the second lens, the third support member is disposed between the third lens and the fourth lens, and the object-side surface of the third support member is at least partially in contact with the image-side surface of the third lens. An effective focal length f2 of the second lens and an outer diameter D2s of the object-side surface of the second support member satisfy: 1.0<f2/D2s<3.2; and an effective focal length f3 of the third lens and an inner diameter d3s of the object-side surface of the third support member satisfy: −2.6<f3/d3s<−1.5. By means of controlling the effective focal lengths of the second lens and the third lens, it is conducive to mutually balancing positive and negative spherical aberrations generated by the second lens and the third lens, so that good imaging quality is able to be ensured; and by means of controlling the inner diameter of the object-side surface of the third support member, redundant stray light is blocked.

In an exemplary embodiment, the support member group further includes a third support member and a third auxiliary support member, the third support member is disposed between the third lens and the fourth lens, the object-side surface of the third support member is at least partially in contact with the image-side surface of the third lens, and the third auxiliary support member is disposed on an image-side surface of the third support member and is partially in contact with the image-side surface of the third support member. The spacing distance T34 between the third lens and the fourth lens on the optical axis, and a maximum thickness CP3 of the third support member and a maximum thickness CP3b of the third auxiliary support member satisfy: 0<(CP3b +CP3)/T34<0.7. By means of controlling the above parameters, on one hand, the maximum thickness of the third support member is directly constrained, thereby facilitating the injection molding of the third support member; and on the other hand, the edge thicknesses of the third lens and the fourth lens are indirectly controlled, so that the two lenses have a proper thickness ratio, thereby facilitating the molding.

In an exemplary embodiment, the support member group may further include a fourth auxiliary support member, which is disposed on the image-side surface of the fourth support member and is at least partially in contact with the image-side surface of the fourth support member. Since an effective diameter edge of the image-side surface of the third lens is farther away from an effective diameter edge of the image-side surface of the fourth lens, by means of disposing the fourth auxiliary support member on the image-side surface of the fourth support member, the edge thicknesses of the third lens and the fourth lens is able to be effectively constrained, thereby facilitating to ensure the injection molding.

In an exemplary embodiment, the optical imaging lens assembly may further include an optical filter used for correcting chromatic aberration and/or protective glass used for protecting a photosensitive element located on the imaging surface.

A second embodiment of the disclosure provides an optical imaging lens assembly, including: a lens barrel, and a lens group and a support member group, which are accommodated in the lens barrel, wherein the lens group includes a first lens, a second lens, a third lens, a fourth lens, a fifth lens and a sixth lens, which are sequentially arranged from an object side to an image side along an optical axis; the support member group includes a fifth support member, the fifth support member is disposed between the fifth lens and the sixth lens, and an object-side surface of the fifth support member is at least partially in contact with an image-side surface of the fifth lens; a spacing distance between the fifth lens and the sixth lens on the optical axis is greater than a spacing distance between any two adjacent lenses among the first lens to the fifth lens on the optical axis; and an outer diameter D5m of an image-side surface of the fifth support member, an inner diameter d5m of the image-side surface of the fifth support member, and a spacing distance T56 between the fifth lens and the sixth lens on the optical axis satisfy: 1.8<(D5m−d5m)/T56<2.8. By means of controlling the above parameters, on one hand, the assembly stability of the sixth lens is ensured; and on the other hand, stray light generated by a front-end lens mechanism is blocked by means of constraining the inner diameter of the image-side surface of the fifth support member, thereby improving the imaging quality.

A third embodiment of the disclosure provides an optical imaging lens assembly, including a lens barrel, and a lens group and a support member group, which are accommodated in the lens barrel, wherein the lens group includes a first lens, a second lens, a third lens, a fourth lens, a fifth lens and a sixth lens, which are sequentially arranged from an object side to an image side along an optical axis; the support member group includes a fifth support member, the fifth support member is disposed between the fifth lens and the sixth lens, and an object-side surface of the fifth support member is at least partially in contact with an image-side surface of the fifth lens; and an inner diameter d5m of an image-side surface of the fifth support member, an effective focal length f6 of the sixth lens, and a refractive index N6 of the sixth lens satisfy: −2.7<d5m/f6*N6<−1.8. By means of controlling the above parameters, the effective focal length and the refractive index of the sixth lens is able to be constrained, which helps to control the direction of rays in the sixth lens; and moreover, stray light generated by a front-end lens mechanism is blocked by means of constraining the inner diameter of the image-side surface of the fifth support member, thereby improving the imaging quality.

It should be understood by those skilled in the art that, without departing from the technical solutions claimed in the disclosure, the number of lenses and the number of support members constituting the optical imaging lens assembly may be changed to obtain various results and advantages described in the present specification.

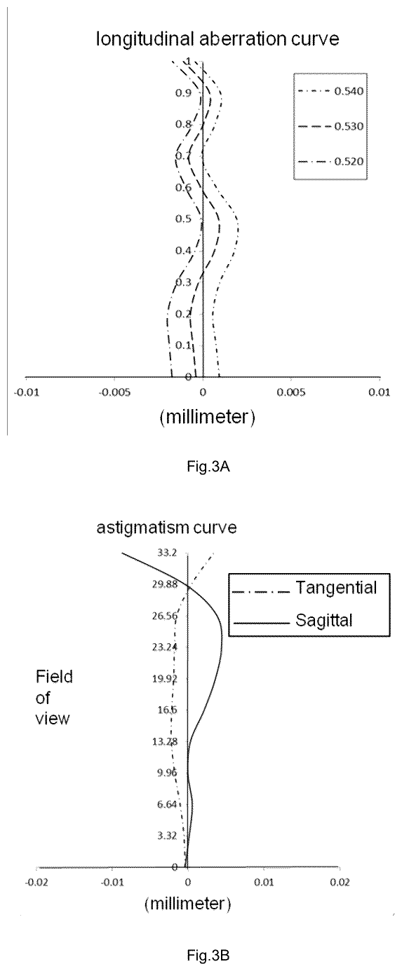

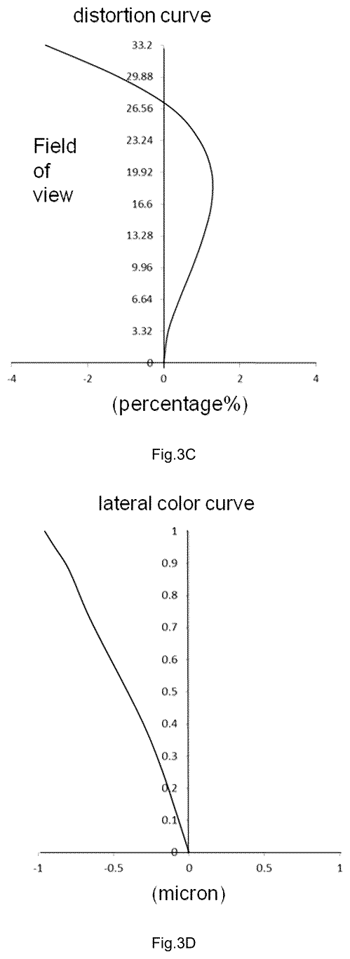

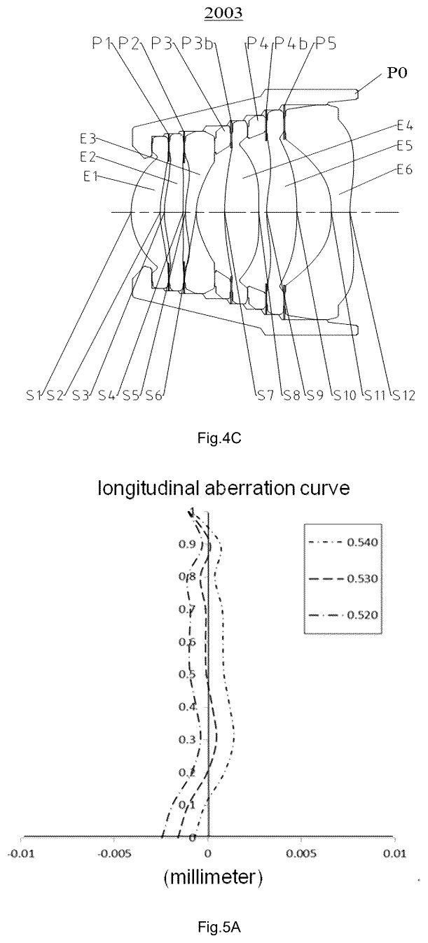

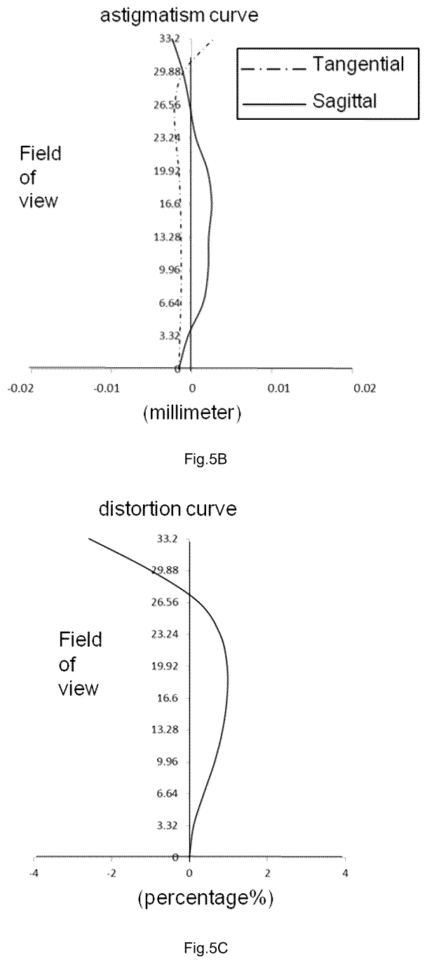

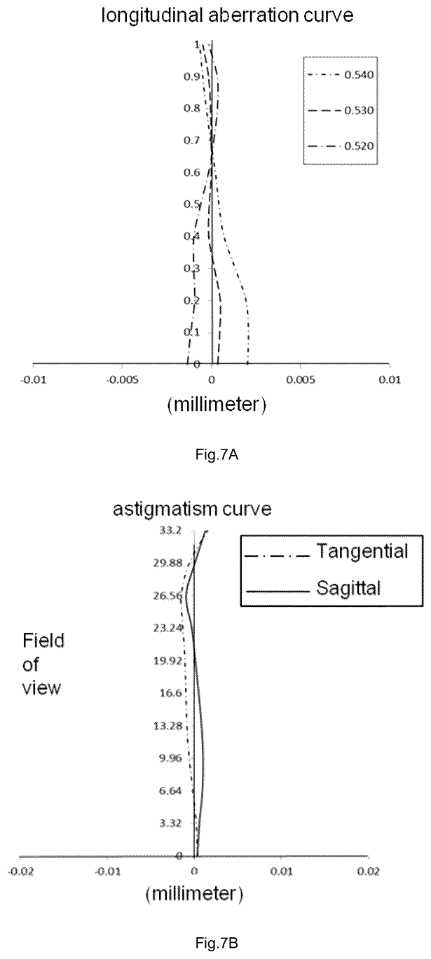

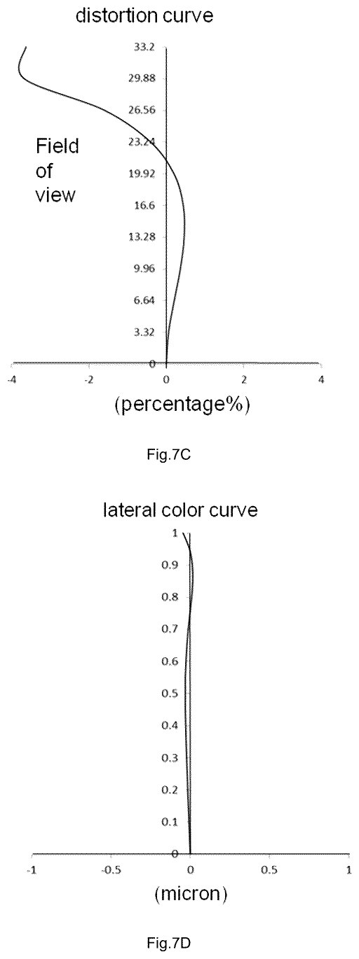

Specific embodiments of the optical imaging lens assembly applicable to the above implementations are further described below with reference to the drawings. Specifically, the optical imaging lens assembly according to Embodiment 1 to Embodiment 3 of the disclosure are described with reference to FIG. 2A to FIG. 3D; the optical imaging lens assembly according to Embodiment 4 to Embodiment 6 of the disclosure are described with reference to FIG. 4A to FIG. 5D; and the optical imaging lens assembly according to Embodiment 7 to Embodiment 9 of the disclosure are described with reference to FIG. 6A to FIG. 7D.

### Embodiment 1

FIG. 2A shows a schematic structural diagram of an optical imaging lens assembly 1001 according to Embodiment 1 of the disclosure. As shown in FIG. 2A, the optical imaging lens assembly 1001 includes a lens barrel P0, and a six-piece lens group and a support member group, which are disposed in the lens barrel P0. The six-piece lens group sequentially includes, from an object side to an image side along an optical axis: a first lens E1, a second lens E2, a third lens E3, a fourth lens E4, a fifth lens E5, and a sixth lens E6. A diaphragm STO is disposed on the object side of the first lens E1.

The first lens E1 has a positive refractive power, an object-side surface S1 thereof is a convex surface, and an image-side surface S2 thereof is a concave surface. The second lens E2 has a positive refractive power, an object-side surface S3 thereof is a convex surface, and an image-side surface S4 thereof is a convex surface. The third lens E3 has a negative refractive power, an object-side surface S5 thereof is a convex surface, and an image-side surface S6 thereof is a concave surface. The fourth lens E4 has a positive refractive power, an object-side surface S7 thereof is a convex surface, and an image-side surface S8 thereof is a concave surface. The fifth lens E5 has a positive refractive power, an object-side surface S9 thereof is a convex surface, and an image-side surface S10 thereof is a convex surface. The sixth lens E6 has a negative refractive power, an object-side surface S11 thereof is a concave surface, and an image-side surface S12 thereof is a concave surface.

The support member group includes a first support member P1, a second support member P2, a third support member P3, a fourth support member P4, a fifth support member P5, a second auxiliary support member P2b, and a fourth auxiliary support member P4b.

The first support member P1 is disposed between the first lens E1 and the second lens E2, and an object-side surface of the first support member P1 is at least partially in contact with the image-side surface S2 of the first lens E1. The second support member P2 is disposed between the second lens E2 and the third lens E3, and an object-side surface of the second support member P2 is at least partially in contact with the image-side surface S4 of the second lens E2. The third support member P3 is disposed between the third lens E3 and the fourth lens E4, and an object-side surface of the third support member P3 is at least partially in contact with the image-side surface S6 of the third lens E3. The fourth support member P4 is disposed between the fourth lens E4 and the fifth lens E5, and an object-side surface of the fourth support member P4 is at least partially in contact with the image-side surface S8 of the fourth lens E4. The fifth support member P5 is disposed between the fifth lens E5 and the sixth lens E6, and an object-side surface of the fifth support member P5 is at least partially in contact with the image-side surface S10 of the fifth lens E5. The second auxiliary support member P2b is disposed on an image-side surface of the second support member P2 and is partially in contact with the image-side surface portion of the second support member P2. The fourth auxiliary support member P4b is disposed on an image-side surface of the fourth support member P4 and is partially in contact with the image-side surface portion of the fourth support member P4.

In an example, an optical filter may also be disposed between the sixth lens E6 and an imaging surface (not shown), and the optical filter has an object-side surface S13 (not shown) and an image-side surface S14 (not shown). Light from an object sequentially passes through the surfaces S1 to S14 and is finally imaged on the imaging surface.

Table 1 shows a basic parameter table of the lens group of the optical imaging lens assembly 1001 in Embodiment 1, wherein a radius of curvature and a thickness/distance are in units of millimeters (mm).

TABLE 1

| | | | | Material | | |
|---|---|---|---|---|---|---|
| Surface | | Radius of | | Refractive | Abbe | Conic |
| number | Surface type | curvature | Thickness | index | number | coefficient |
| OBJ | Spherical surface | Infinite | Infinite | | | |
| STO | Spherical surface | Infinite | Infinite | | | |
| S1 | Aspheric surface | 1.9584 | 0.2440 | 1.55 | 56.09 | 0.0000 |
| S2 | Aspheric surface | 17.1051 | 0.0424 | | | 0.0000 |
| S3 | Aspheric surface | 18.6634 | 0.5594 | 1.55 | 56.09 | 0.0000 |
| S4 | Aspheric surface | −7.6753 | 0.0274 | | | 0.0000 |
| S5 | Aspheric surface | 1.6072 | 0.1786 | 1.68 | 19.24 | 0.0000 |
| S6 | Aspheric surface | 1.0635 | 0.4981 | | | 0.0000 |
| S7 | Aspheric surface | 8.8069 | 0.3634 | 1.65 | 23.29 | 0.0000 |
| S8 | Aspheric surface | 17.0307 | 0.1644 | | | 0.0000 |
| S9 | Aspheric surface | 2.1400 | 0.5285 | 1.57 | 37.31 | 0.0000 |
| S10 | Aspheric surface | −9.4602 | 0.6398 | | | 0.0000 |
| S11 | Aspheric surface | −5.0472 | 0.3000 | 1.65 | 23.53 | 0.0000 |
| S12 | Aspheric surface | 1.8943 | 0.0920 | | | 0.0000 |
| S13 | Spherical surface | Infinite | 0.2100 | 1.52 | 64.17 | |
| S14 | Spherical surface | Infinite | 0.0902 | | | |

In the present embodiment, both the object-side surface and the image-side surface of any of the first lens E1 to the sixth lens E6 are aspheric surfaces, and the surface types x of the aspheric lenses may be defined by using, but not limited to, the following aspheric formula:

$$x = \frac{{ch}^{2}}{1 + \sqrt{1 - ( k + 1 ) {c}^{2} {h}^{2}}} + \sum \text{?} \qquad ( 1 )$$

$$\text{?} \text{indicates text missing or illegible when filed}$$

wherein x is a distance vector height from the vertex of the aspheric surface when the height of the aspheric surface in the direction of the optical axis is h; c is an paraxial curvature of the aspheric surface, c=1/R (that is, the paraxial curvature c is a reciprocal of the radius of curvature R in Table 1); k is a conic coefficient; and Ai is a correction coefficient of an i-th order of the aspheric surface. Table 2 shows high-order coefficients A₄, A₆, A₈, A₁₀, A₁₂, A₁₄, A₁₆ and A₁₈ that may be used for the aspheric surfaces S1-S12 in Embodiment 1.

TABLE 2

| Surface | | | | | | | | |
|---|---|---|---|---|---|---|---|---|
| number | A4 | A6 | A8 | A10 | A12 | A14 | A16 | A18 |
| S1 | −9.1942E−02 | 6.8259E−04 | 7.5444E−04 | −5.6050E−04 | −8.3333E−05 | 6.0638E−05 | 1.4425E−05 | 2.6351E−07 |
| S2 | 9.1837E−02 | 1.1047E−03 | −9.1518E−04 | −4.5632E−04 | −1.2788E−05 | 7.3535E−05 | 4.7415E−06 | 0.0000E+00 |
| S3 | 2.3452E−01 | −1.2675E−02 | −1.9698E−03 | −3.8172E−05 | 2.2403E−05 | −4.0586E−05 | −1.7582E−05 | −5.1693E−07 |
| S4 | −2.5878E−02 | −5.7640E−03 | 1.9580E−03 | −7.7413E−04 | 5.4147E−05 | −1.0693E−05 | −1.0646E−05 | 0.0000E+00 |
| S5 | −2.9389E−01 | 2.8847E−02 | −3.5848E−04 | −4.6396E−04 | 1.0189E−04 | 6.7663E−05 | −3.1374E−05 | 0.0000E+00 |
| S6 | −3.2923E−01 | 6.2290E−03 | −7.5162E−03 | −1.6613E−03 | −6.7960E−04 | −2.0493E−04 | −1.0629E−04 | 0.0000E+00 |
| S7 | −3.4442E−02 | 1.8778E−03 | 5.2054E−05 | 1.4495E−03 | 1.4304E−04 | 7.7431E−05 | −2.6870E−06 | 0.0000E+00 |
| S8 | −2.5956E−01 | 2.4228E−02 | −5.8044E−03 | 2.0115E−03 | −1.4509E−04 | 1.0709E−04 | −2.6662E−05 | −3.9212E−07 |
| S9 | −3.4788E−01 | 3.2775E−02 | −4.0486E−03 | 1.1327E−03 | −4.5281E−04 | 1.4122E−04 | −1.3292E−05 | 0.0000E+00 |
| S10 | −5.6636E−02 | −9.1695E−03 | 3.1900E−03 | −1.5406E−03 | 1.3878E−04 | 1.4594E−04 | 8.1058E−05 | 6.3795E−07 |
| S1 | −5.9716E−01 | 1.0131E−01 | −2.0439E−02 | 2.9527E−03 | −2.7973E−04 | 3.3583E−04 | −5.2254E−05 | −3.8202E−06 |
| S12 | −1.2973E+00 | 9.3946E−02 | −5.3892E−02 | 1.1251E−02 | −3.7551E−03 | 1.3137E−03 | −6.0277E−04 | −2.7451E−05 |

### Embodiment 2

FIG. 2B shows a schematic structural diagram of an optical imaging lens assembly 1002 according to Embodiment 2 of the disclosure. As shown in FIG. 2B, the optical imaging lens assembly 1002 includes a lens barrel P0, and a six-piece lens group and a support member group, which are disposed in the lens barrel P0. The six-piece lens group sequentially includes, from an object side to an image side along an optical axis: a first lens E1, a second lens E2, a third lens E3, a fourth lens E4, a fifth lens E5, and a sixth lens E6. A diaphragm ST0 is disposed on the object side of the first lens E1. The support member group includes a first support member P1, a second support member P2, a third support member P3, a fourth support member P4, a fifth support member P5, a second auxiliary support member P2b, and a fourth auxiliary support member P4b.

The six-piece lens group of the optical imaging lens assembly 1002 in the present embodiment has the same structure as the six-piece lens group 1001 of the optical imaging lens assembly in Embodiment 1, and basic parameters thereof are detailed in Table 1 and Table 2, therefore details are not repeated again.

The difference between the present embodiment and Embodiment 1 lies in that at least part of elements in the lens barrel P0 and the support member group have different structure sizes.

### Embodiment 3

FIG. 2C shows a schematic structural diagram of an optical imaging lens assembly 1003 according to Embodiment 3 of the disclosure. As shown in FIG. 2C, the optical imaging lens assembly 1003 includes a lens barrel P0, and a six-piece lens group and a support member group, which are disposed in the lens barrel P0. The six-piece lens group sequentially includes, from an object side to an image side along an optical axis: a first lens E1, a second lens E2, a third lens E3, a fourth lens E4, a fifth lens E5, and a sixth lens E6. A diaphragm STO is disposed on the object side of the first lens E1. The support member group includes a first support member P1, a second support member P2, a third support member P3, a fourth support member P4, a fifth support member P5, a second auxiliary support member P2b, and a fourth auxiliary support member P4b.

The six-piece lens group of the optical imaging lens assembly 1003 in the present embodiment has the same structure as the six-piece lens group of the optical imaging lens assembly 1001 in Embodiment 1, and basic parameters thereof are detailed in Table 1 and Table 2, therefore details are not repeated again.

The difference between the present embodiment and Embodiment 1 lies in that at least part of elements in the lens barrel P0 and the support member group have different structure sizes.

FIG. 3A shows a longitudinal aberration curve of the optical imaging lens assembly in Embodiment 1 to Embodiment 3, which represents deviations of focal points of rays of different wavelengths after passing through the lens. FIG. 3B shows an astigmatism curve of the optical imaging lens assembly in Embodiment 1 to Embodiment 3, which represents tangential image surface bending and sagittal image surface bending. FIG. 3C shows a distortion curve of the optical imaging lens assembly in Embodiment 1 to Embodiment 3, which represents distortion values corresponding to different angles of field of view. FIG. 3D shows a lateral color curve of the optical imaging lens assembly in Embodiment 1 to Embodiment 3, which represents deviations of different image heights on the imaging surface after the rays pass through the lens. It is able to be seen from FIG. 3A to FIG. 3D that the optical imaging lens assembly provided in Embodiment 1 to Embodiment 3 may achieve good imaging quality.

### Embodiment 4

FIG. 4A shows a schematic structural diagram of an optical imaging lens assembly 2001 according to Embodiment 4 of the disclosure. As shown in FIG. 4A, the optical imaging lens assembly 2001 includes a lens barrel P0, and a six-piece lens group and a support member group, which are disposed in the lens barrel P0. The six-piece lens group sequentially includes, from an object side to an image side along an optical axis: a first lens E1, a second lens E2, a third lens E3, a fourth lens E4, a fifth lens E5, and a sixth lens E6. A diaphragm STO is disposed on the object side of the first lens E1.

The first lens E1 has a positive refractive power, an object-side surface S1 thereof is a convex surface, and an image-side surface S2 thereof is a concave surface. The second lens E2 has a positive refractive power, an object-side surface S3 thereof is a convex surface, and an image-side surface S4 thereof is a convex surface. The third lens E3 has a negative refractive power, an object-side surface S5 thereof is a convex surface, and an image-side surface S6 thereof is a concave surface. The fourth lens E4 has a positive refractive power, an object-side surface S7 thereof is a convex surface, and an image-side surface S8 thereof is a concave surface. The fifth lens E5 has a positive refractive power, an object-side surface S9 thereof is a convex surface, and an image-side surface S10 thereof is a convex surface. The sixth lens E6 has a negative refractive power, an object-side surface S11 thereof is a concave surface, and an image-side surface S12 thereof is a concave surface.

The support member group includes a first support member P1, a second support member P2, a third support member P3, a fourth support member P4, a fifth support member P5, a third auxiliary support member P3b, and a fourth auxiliary support member P4b.

The first support member P1 is disposed between the first lens E1 and the second lens E2, and an object-side surface of the first support member P1 is at least partially in contact with the image-side surface S2 of the first lens E1. The second support member P2 is disposed between the second lens E2 and the third lens E3, and an object-side surface of the second support member P2 is at least partially in contact with the image-side surface S4 of the second lens E2. The third support member P3 is disposed between the third lens E3 and the fourth lens E4, and an object-side surface of the third support member P3 is at least partially in contact with the image-side surface S6 of the third lens E3. The fourth support member P4 is disposed between the fourth lens E4 and the fifth lens E5, and an object-side surface of the fourth support member P4 is at least partially in contact with the image-side surface S8 of the fourth lens E4. The fifth support member P5 is disposed between the fifth lens E5 and the sixth lens E6, and an object-side surface of the fifth support member P5 is at least partially in contact with the image-side surface S10 of the fifth lens E5. The third auxiliary support member P3b is disposed on an image-side surface of the third support member P3 and is partially in contact with the image-side surface portion of the third support member P3. The fourth auxiliary support member P4b is disposed on an image-side surface of the fourth support member P4 and is partially in contact with the image-side surface portion of the fourth support member P4.

In an example, an optical filter may also be disposed between the sixth lens E6 and an imaging surface (not shown), and the optical filter has an object-side surface S13 (not shown) and an image-side surface S14 (not shown). Light from an object sequentially passes through the surfaces S1 to S14 and is finally imaged on the imaging surface.

Table 3 shows a basic parameter table of the lens group of the optical imaging lens assembly 2001 in Embodiment 4, wherein a radius of curvature and a thickness/distance are in units of millimeters (mm).

TABLE 3

| | | | | Material | | |
|---|---|---|---|---|---|---|
| Surface | | Radius of | | Refractive | Abbe | Conic |
| number | Surface type | curvature | Thickness | index | number | coefficient |
| OBJ | Spherical surface | Infinite | Infinite | | | |
| STO | Spherical surface | Infinite | Infinite | | | |
| S1 | Aspheric surface | 1.5086 | 0.4727 | 1.55 | 56.09 | 0.0000 |
| S2 | Aspheric surface | 2.1217 | 0.0682 | | | 0.0000 |
| S3 | Aspheric surface | 2.0993 | 0.3043 | 1.55 | 56.09 | 0.0000 |
| S4 | Aspheric surface | −75.0663 | 0.0381 | | | 0.0000 |
| S5 | Aspheric surface | 2.0215 | 0.1744 | 1.68 | 19.24 | 0.0000 |
| S6 | Aspheric surface | 1.0967 | 0.4609 | | | 0.0000 |
| S7 | Aspheric surface | 4.7429 | 0.5540 | 1.59 | 28.23 | 0.0000 |
| S8 | Aspheric surface | 13.0340 | 0.1290 | | | 0.0000 |
| S9 | Aspheric surface | 2.3795 | 0.4923 | 1.59 | 28.23 | 0.0000 |
| S10 | Aspheric surface | −4.5282 | 0.5598 | | | 0.0000 |
| S11 | Aspheric surface | −2.6699 | 0.3000 | 1.68 | 19.24 | 0.0000 |
| S12 | Aspheric surface | 2.3471 | 0.0724 | | | 0.0000 |
| S13 | Spherical surface | Infinite | 0.2100 | 1.52 | 64.17 | |
| S14 | Spherical surface | Infinite | 0.0901 | | | |

In the present embodiment, both the object-side surface and the image-side surface of any of the first lens E1 to the sixth lens E6 are aspheric surfaces. Table 4 shows high-order coefficients A₄, A₆, A₈, A₁₀, A₁₂, A₁₄, A₁₆ and A₁₈ that may be used for the aspheric surfaces S1-S12 in Embodiment 1.

TABLE 4

| Surface | | | | | | | | |
|---|---|---|---|---|---|---|---|---|
| number | A4 | A6 | A8 | A10 | A12 | A14 | A16 | A18 |
| S1 | 9.4082E−03 | 4.4867E−03 | 1.1802E−03 | 2.7975E−04 | 6.9154E−05 | 1.1259E−05 | 4.5989E−06 | 4.6666E−07 |
| S2 | −1.3161E−01 | 1.0331E−02 | 3.7122E−03 | −3.4359E−04 | 1.0551E−04 | −3.2018E−05 | −8.4953E−06 | 0.0000E+00 |
| S3 | −1.5102E−01 | 7.6765E−03 | 5.9170E−03 | −5.2828E−04 | 1.3366E−04 | −9.7789E−07 | −2.1181E−05 | 0.0000E+00 |
| S4 | 3.8345E−03 | −7.3121E−03 | 3.7125E−03 | 3.0810E−04 | 2.3144E−04 | −1.7386E−05 | −1.0079E−05 | 0.0000E+00 |
| S5 | −1.8873E−01 | 4.7536E−03 | −1.1653E−03 | 1.0818E−03 | −1.0504E−04 | −4.2328E−05 | −1.7392E−05 | 0.0000E+00 |
| S6 | −2.5650E−01 | 8.4265E−03 | −4.1362E−03 | 6.3149E−04 | −3.4461E−04 | 1.5647E−05 | −8.1172E−06 | 0.0000E+00 |
| S7 | −4.5618E−02 | 4.7123E−03 | −1.0144E−03 | 7.1841E−04 | 1.4732E−04 | 3.8301E−05 | −1.4603E−05 | 0.0000E+00 |
| S8 | −4.0488E−01 | 4.3851E−02 | −8.0265E−03 | 1.5867E−03 | 3.2432E−04 | 1.7993E−04 | 1.2694E−05 | 0.0000E+00 |
| S9 | −4.4923E−01 | 4.8480E−02 | −3.3291E−03 | 3.6570E−04 | 3.0819E−04 | 2.6932E−06 | −1.0344E−04 | 0.0000E+00 |
| S10 | −5.9249E−02 | −1.2507E−03 | 6.2676E−03 | −1.4877E−03 | 5.4272E−04 | −3.4594E−05 | −6.8140E−05 | −1.2993E−06 |
| S11 | −4.1435E−01 | 8.5451E−02 | −1.8936E−02 | 4.8471E−03 | −5.3483E−04 | −4.8903E−05 | −7.5467E−05 | −1.0022E−05 |
| S12 | −1.0022E+00 | 9.3580E−02 | −4.1649E−02 | 1.4268E−02 | −2.6518E−03 | 9.5586E−04 | −4.6206E−04 | −2.5281E−06 |

### Embodiment 5

FIG. 4B shows a schematic structural diagram of an optical imaging lens assembly 2002 according to Embodiment 5 of the disclosure. As shown in FIG. 4B, the optical imaging lens assembly 2002 includes a lens barrel P0, and a six-piece lens group and a support member group, which are disposed in the lens barrel P0. The six-piece lens group sequentially includes, from an object side to an image side along an optical axis: a first lens E1, a second lens E2, a third lens E3, a fourth lens E4, a fifth lens E5, and a sixth lens E6. A diaphragm STO is disposed on the object side of the first lens E1. The support member group includes a first support member P1, a second support member P2, a third support member P3, a fourth support member P4, a fifth support member P5, a third auxiliary support member P3b, and a fourth auxiliary support member P4b.

The six-piece lens group of the optical imaging lens assembly 2002 in the present embodiment has the same structure as the six-piece lens group of the optical imaging lens assembly 2001 in Embodiment 4, and basic parameters thereof are detailed in Table 3 and Table 4, therefore details are not repeated again.

The difference between the present embodiment and Embodiment 4 lies in that at least part of elements in the lens barrel P0 and the support member group have different structure sizes.

### Embodiment 6

FIG. 4C shows a schematic structural diagram of an optical imaging lens assembly 2003 according to Embodiment 6 of the disclosure. As shown in FIG. 4C, the optical imaging lens assembly 2003 includes a lens barrel P0, and a six-piece lens group and a support member group, which are disposed in the lens barrel P0. The six-piece lens group sequentially includes, from an object side to an image side along an optical axis: a first lens E1, a second lens E2, a third lens E3, a fourth lens E4, a fifth lens E5, and a sixth lens E6. A diaphragm STO is disposed on the object side of the first lens E1. The support member group includes a first support member P1, a second support member P2, a third support member P3, a fourth support member P4, a fifth support member P5, a third auxiliary support member P3b, and a fourth auxiliary support member P4b.

The six-piece lens group of the optical imaging lens assembly 2003 in the present embodiment has the same structure as the six-piece lens group of the optical imaging lens assembly 2001 in Embodiment 4, and basic parameters thereof are detailed in Table 3 and Table 4, therefore details are not repeated again.

The difference between the present embodiment and Embodiment 4 lies in that at least part of elements in the lens barrel P0 and the support member group have different structure sizes.

FIG. 5A shows a longitudinal aberration curve of the optical imaging lens assembly in

Embodiment 4 to Embodiment 6, which represents deviations of focal points of rays of different wavelengths after passing through the lens. FIG. 5B shows an astigmatism curve of the optical imaging lens assembly in Embodiment 4 to Embodiment 6, which represents tangential image surface bending and sagittal image surface bending. FIG. 5C shows a distortion curve of the optical imaging lens assembly in Embodiment 4 to Embodiment 6, which represents distortion values corresponding to different angles of field of view. FIG. 5D shows a lateral color curve of the optical imaging lens assembly in Embodiment 4 to Embodiment 6, which represents deviations of different image heights on the imaging surface after the rays pass through the lens. It is able to be seen from FIG. 5A to FIG. 5D that the optical imaging lens assembly provided in Embodiment 4 to Embodiment 6 may achieve good imaging quality.

### Embodiment 7

FIG. 6A shows a schematic structural diagram of an optical imaging lens assembly 3001 according to Embodiment 7 of the disclosure. As shown in FIG. 6A, the optical imaging lens assembly 3001 includes a lens barrel P0, and a six-piece lens group and a support member group, which are disposed in the lens barrel P0. The six-piece lens group sequentially includes, from an object side to an image side along an optical axis: a first lens E1, a second lens E2, a third lens E3, a fourth lens E4, a fifth lens E5, and a sixth lens E6. A diaphragm STO is disposed on the object side of the first lens E1.

The first lens E1 has a positive refractive power, an object-side surface S1 thereof is a convex surface, and an image-side surface S2 thereof is a concave surface. The second lens E2 has a positive refractive power, an object-side surface S3 thereof is a convex surface, and an image-side surface S4 thereof is a convex surface. The third lens E3 has a negative refractive power, an object-side surface S5 thereof is a convex surface, and an image-side surface S6 thereof is a concave surface. The fourth lens E4 has a positive refractive power, an object-side surface S7 thereof is a convex surface, and an image-side surface S8 thereof is a concave surface. The fifth lens E5 has a positive refractive power, an object-side surface S9 thereof is a convex surface, and an image-side surface S10 thereof is a convex surface. The sixth lens E6 has a negative refractive power, an object-side surface S11 thereof is a concave surface, and an image-side surface S12 thereof is a concave surface.

The support member group includes a first support member P1, a second support member P2, a third support member P3, a fourth support member P4, a fifth support member P5, and a third auxiliary support member P3b.

The first support member P1 is disposed between the first lens E1 and the second lens E2, and an object-side surface of the first support member P1 is at least partially in contact with the image-side surface S2 of the first lens E1. The second support member P2 is disposed between the second lens E2 and the third lens E3, and an object-side surface of the second support member P2 is at least partially in contact with the image-side surface S4 of the second lens E2. The third support member P3 is disposed between the third lens E3 and the fourth lens E4, and an object-side surface of the third support member P3 is at least partially in contact with the image-side surface S6 of the third lens E3. The fourth support member P4 is disposed between the fourth lens E4 and the fifth lens E5, and an object-side surface of the fourth support member P4 is at least partially in contact with the image-side surface S8 of the fourth lens E4. The fifth support member P5 is disposed between the fifth lens E5 and the sixth lens E6, and an object-side surface of the fifth support member P5 is at least partially in contact with the image-side surface S10 of the fifth lens E5. The third auxiliary support member P3b is disposed on an image-side surface of the third support member P3 and is partially in contact with the image-side surface portion of the third support member P3.

In an example, an optical filter may also be disposed between the sixth lens E6 and an imaging surface (not shown), and the optical filter has an object-side surface S13 (not shown) and an image-side surface S14 (not shown). Light from an object sequentially passes through the surfaces S1 to S14 and is finally imaged on the imaging surface.

Table 5 shows a basic parameter table of the lens group of the optical imaging lens assembly 3001 in Embodiment 1, wherein a radius of curvature and a thickness/distance are in units of millimeters (mm).

TABLE 5

| | | | | Material | | |
|---|---|---|---|---|---|---|
| Surface | | Radius of | | Refractive | Abbe | Conic |
| number | Surface type | curvature | Thickness | index | number | coefficient |
| OBJ | Spherical surface | Infinite | Infinite | | | |
| STO | Spherical surface | Infinite | Infinite | | | |
| S1 | Aspheric surface | 3.7150 | 0.2000 | 1.57 | 37.31 | 0.0000 |
| S2 | Aspheric surface | 76.2623 | 0.0559 | | | 0.0000 |
| S3 | Aspheric surface | 7.4458 | 0.6934 | 1.55 | 56.09 | 0.0000 |
| S4 | Aspheric surface | −3.3897 | 0.0089 | | | 0.0000 |
| S5 | Aspheric surface | 1.7761 | 0.2396 | 1.68 | 19.24 | 0.0000 |
| S6 | Aspheric surface | 1.0951 | 0.4824 | | | 0.0000 |
| S7 | Aspheric surface | 7.1110 | 0.3737 | 1.57 | 37.31 | 0.0000 |
| S8 | Aspheric surface | 14.3314 | 0.1100 | | | 0.0000 |
| S9 | Aspheric surface | 2.2121 | 0.4651 | 1.55 | 56.09 | 0.0000 |
| S10 | Aspheric surface | −30.6557 | 0.7389 | | | 0.0000 |
| S11 | Aspheric surface | −2.5689 | 0.3000 | 1.57 | 37.31 | 0.0000 |
| S12 | Aspheric surface | 2.7091 | 0.0837 | | | 0.0000 |
| S13 | Spherical surface | Infinite | 0.2100 | 1.52 | 64.17 | |
| S14 | Spherical surface | Infinite | 0.0901 | | | |

In the present embodiment, both the object-side surface and the image-side surface of any of the first lens E1 to the sixth lens E6 are aspheric surfaces. Table 6 shows high-order coefficients A₄, A₆, A₈, A₁₀, A₁₂, A₁₄, A₁₆ and A₁₈ that may be used for the aspheric surfaces S1-S12 in Embodiment 1.

TABLE 6

| Surface | | | | | | | | |
|---|---|---|---|---|---|---|---|---|
| number | A4 | A6 | A8 | A10 | A12 | A14 | A16 | A18 |
| S1 | −1.4081E−01 | 9.5281E−03 | 8.9542E−04 | −4.9962E−04 | 4.8511E−05 | 5.8442E−08 | −1.3370E−06 | 0.0000E+00 |
| S2 | 1.3941E−02 | −2.3437E−03 | 3.5548E−03 | −9.4664E−04 | 9.1884E−05 | −3.8632E−06 | −2.7235E−06 | 0.0000E+00 |
| S3 | 2.3827E−01 | −3.5334E−02 | 5.5578E−03 | −8.8878E−04 | 2.4111E−04 | 1.7670E−06 | 6.9075E−06 | 0.0000E+00 |
| S4 | −6.4151E−03 | −2.9335E−03 | 1.7731E−03 | −1.1338E−04 | 7.1193E−05 | 2.1188E−05 | 2.9479E−06 | 0.0000E+00 |
| S5 | −2.5133E−01 | 3.1625E−02 | 2.2899E−04 | −1.8892E−04 | −4.4482E−05 | 3.5464E−05 | −1.0012E−05 | 0.0000E+00 |
| S6 | −2.7453E−01 | 5.5591E−03 | −3.8911E−03 | −6.5819E−04 | −3.0846E−04 | −7.0857E−05 | −3.2574E−05 | −9.2873E−06 |
| S7 | 1.0951E−01 | −4.2696E−03 | −2.9685E−04 | 4.9933E−04 | −3.1797E−04 | −8.4740E−05 | −1.4112E−05 | 0.0000E+00 |
| S8 | −9.4589E−02 | 3.4574E−02 | −4.9479E−03 | 1.6031E−03 | −1.0082E−03 | −3.0246E−04 | −1.4967E−04 | 0.0000E+00 |
| S9 | −3.0102E−01 | 2.2951E−02 | 2.1208E−03 | 3.9187E−03 | −5.1181E−04 | −1.5104E−04 | −1.6834E−04 | −1.9330E−06 |
| S10 | −1.1905E−02 | −2.5457E−02 | 5.7932E−03 | 7.5039E−04 | 4.6934E−04 | 1.1600E−04 | 3.5824E−05 | 0.0000E+00 |
| S11 | −3.4019E−01 | 6.5958E−02 | −9.8458E−03 | 4.5400E−04 | −9.9940E−04 | 3.8724E−05 | −3.2559E−05 | −4.5325E−06 |
| S12 | −7.3787E−01 | 6.4987E−02 | −2.4937E−02 | 7.3306E−03 | −1.2145E−03 | 7.3065E−04 | −1.6250E−04 | −2.0744E−07 |

### Embodiment 8

FIG. 6B shows a schematic structural diagram of an optical imaging lens assembly 3002 according to Embodiment 8 of the disclosure. As shown in FIG. 6B, the optical imaging lens assembly 3002 includes a lens barrel P0, and a six-piece lens group and a support member group, which are disposed in the lens barrel P0. The six-piece lens group sequentially includes, from an object side to an image side along an optical axis: a first lens E1, a second lens E2, a third lens E3, a fourth lens E4, a fifth lens E5, and a sixth lens E6. A diaphragm STO is disposed on the object side of the first lens E1. The support member group includes a first support member P1, a second support member P2, a third support member P3, a fourth support member P4, a fifth support member P5, and a third auxiliary support member P3b.

The six-piece lens group of the optical imaging lens assembly 3002 in the present embodiment has the same structure as the six-piece lens group of the optical imaging lens assembly 3001 in Embodiment 7, and basic parameters thereof are detailed in Table 5 and Table 6, therefore details are not repeated again.

The difference between the present embodiment and Embodiment 7 lies in that at least part of elements in the lens barrel P0 and the support member group have different structure sizes.

### Embodiment 9

FIG. 6C shows a schematic structural diagram of an optical imaging lens assembly 3003 according to Embodiment 9 of the disclosure. As shown in FIG. 6C, the optical imaging lens assembly 3003 includes a lens barrel P0, and a six-piece lens group and a support member group, which are disposed in the lens barrel P0. The six-piece lens group sequentially includes, from an object side to an image side along an optical axis: a first lens E1, a second lens E2, a third lens E3, a fourth lens E4, a fifth lens E5, and a sixth lens E6. A diaphragm STO is disposed on the object side of the first lens E1. The support member group includes a first support member P1, a second support member P2, a third support member P3, a fourth support member P4, a fifth support member P5, and a third auxiliary support member P3b.

The six-piece lens group of the optical imaging lens assembly 3003 in the present embodiment has the same structure as the six-piece lens group 3001 of the optical imaging lens assembly in Embodiment 7, and basic parameters thereof are detailed in Table 5 and Table 6, therefore details are not repeated again.

The difference between the present embodiment and Embodiment 7 lies in that at least part of elements in the lens barrel P0 and the support member group have different structure sizes.

FIG. 7A shows a longitudinal aberration curve of the optical imaging lens assembly in Embodiment 7 to Embodiment 9, which represents deviations of focal points of rays of different wavelengths after passing through the lens. FIG. 7B shows an astigmatism curve of the optical imaging lens assembly in Embodiment 7 to Embodiment 9, which represents tangential image surface bending and sagittal image surface bending. FIG. 7C shows a distortion curve of the optical imaging lens assembly in Embodiment 7 to Embodiment 9, which represents distortion values corresponding to different angles of field of view. FIG. 7D shows a lateral color curve of the optical imaging lens assembly in Embodiment 7 to Embodiment 9, which represents deviations of different image heights on the imaging surface after the rays pass through the lens. It is able to be seen from FIG. 7A to FIG. 7D that the optical imaging lens assembly provided in Embodiment 7 to Embodiment 9 may achieve good imaging quality.

Table 7 shows values of parameters EPD, f, f1, f2, f3, f4, f5, f6, f12, SAG61 and the like in various embodiments among Embodiment 1 to Embodiment 9, wherein EPD, f, f1, f2, f3, f4, f5, f6, f12, SAG61 in Table 7 are all in units of millimeters (mm).

TABLE 7

| | embodiment | | | | | | | | |
|---|---|---|---|---|---|---|---|---|---|
| Parameter | 1 | 2 | 3 | 4 | 5 | 6 | 7 | 8 | 9 |
| EPD | 1.9985 | 1.9985 | 1.9985 | 1.9896 | 1.9896 | 1.9896 | 2.0413 | 2.0413 | 2.0413 |
| f | 2.8904 | 2.8904 | 2.8904 | 2.8777 | 2.8777 | 2.8777 | 2.9954 | 2.9954 | 2.9954 |
| f1 | 4.0160 | 4.0160 | 4.0160 | 7.4911 | 7.4911 | 7.4911 | 6.8098 | 6.8098 | 6.8098 |
| f2 | 10.0078 | 10.0078 | 10.0078 | 3.7348 | 3.7348 | 3.7348 | 4.3525 | 4.3525 | 4.3525 |
| f3 | −5.3074 | −5.3074 | −5.3074 | −3.7990 | −3.7990 | −3.7990 | −4.8762 | −4.8762 | −4.8762 |
| f4 | 27.6425 | 27.6425 | 27.6425 | 12.3005 | 12.3005 | 12.3005 | 24.1805 | 24.1805 | 24.1805 |
| f5 | 3.0977 | 3.0977 | 3.0977 | 2.7090 | 2.7090 | 2.7090 | 3.7870 | 3.7870 | 3.7870 |
| f6 | −2.0865 | −2.0865 | −2.0865 | −1.7845 | −1.7845 | −1.7845 | −2.2549 | −2.2549 | −2.2549 |
| f12 | 2.9670 | 2.9670 | 2.9670 | 2.7105 | 2.7105 | 2.7105 | 2.7810 | 2.7810 | 2.7810 |
| SAG61 | −0.6979 | −0.6979 | −0.6979 | −0.7304 | −0.7304 | −0.7304 | −0.6824 | −0.6824 | −0.6824 |

Table 8 shows values of parameters D1m, d2s, D2s, d3s, d4m, d5s, d5m, D5s, D5m, d0s, D0m, EP01, CP1, EP12, CP2, EP23, CP3, EP34, EP45, CP5, CP3b and the like in various embodiments among Embodiment 1 to Embodiment 9, wherein the above parameters may be measured according to a labeling method shown in FIG. 1, and the parameters shown in Table 8 are all in units of millimeters (mm).

TABLE 8

| | embodiment | | | | | | | | |
|---|---|---|---|---|---|---|---|---|---|
| Parameter | 1 | 2 | 3 | 4 | 5 | 6 | 7 | 8 | 9 |
| D1m | 3.200 | 3.300 | 3.100 | 3.100 | 3.200 | 3.000 | 3.400 | 3.300 | 3.500 |
| d2s | 2.096 | 2.096 | 2.093 | 1.884 | 1.879 | 1.888 | 2.210 | 2.217 | 2.205 |
| D2s | 3.300 | 3.400 | 3.200 | 3.200 | 3.300 | 3.100 | 3.500 | 3.400 | 3.600 |
| d3s | 2.073 | 2.095 | 2.122 | 1.949 | 1.975 | 2.285 | 2.048 | 2.080 | 2.759 |
| d4m | 2.474 | 2.468 | 2.920 | 2.603 | 2.590 | 3.086 | 2.621 | 2.606 | 2.639 |
| d5s | 2.755 | 2.775 | 2.767 | 2.774 | 2.780 | 2.780 | 2.771 | 2.781 | 2.781 |
| d5m | 2.755 | 2.775 | 2.767 | 2.774 | 2.780 | 2.780 | 2.771 | 2.781 | 2.781 |
| D5s | 4.200 | 4.300 | 4.100 | 4.200 | 4.300 | 4.400 | 4.283 | 4.183 | 4.383 |
| D5m | 4.200 | 4.300 | 4.100 | 4.200 | 4.300 | 4.100 | 4.283 | 4.183 | 4.383 |
| d0s | 2.463 | 2.563 | 2.463 | 2.557 | 2.563 | 2.557 | 2.486 | 2.424 | 2.598 |
| D0m | 4.773 | 4.873 | 4.673 | 4.750 | 4.850 | 4.650 | 4.832 | 4.732 | 4.932 |
| EP01 | 0.529 | 0.499 | 0.513 | 0.638 | 0.602 | 0.580 | 0.593 | 0.574 | 0.602 |
| CP1 | 0.018 | 0.022 | 0.012 | 0.018 | 0.022 | 0.016 | 0.018 | 0.022 | 0.016 |
| EP12 | 0.311 | 0.321 | 0.314 | 0.241 | 0.249 | 0.233 | 0.628 | 0.584 | 0.604 |
| CP2 | 0.018 | 0.022 | 0.012 | 0.018 | 0.022 | 0.016 | 0.018 | 0.022 | 0.016 |
| EP23 | 0.662 | 0.666 | 0.672 | 0.474 | 0.470 | 0.489 | 0.682 | 0.730 | 0.664 |
| CP3 | 0.018 | 0.022 | 0.016 | 0.018 | 0.012 | 0.259 | 0.018 | 0.016 | 0.303 |
| EP34 | 0.335 | 0.307 | 0.308 | 0.524 | 0.468 | 0.275 | 0.555 | 0.505 | 0.303 |
| EP45 | 0.660 | 0.664 | 0.289 | 0.547 | 0.566 | 0.295 | 0.403 | 0.446 | 0.393 |
| CP5 | 0.018 | 0.022 | 0.016 | 0.018 | 0.022 | 0.016 | 0.018 | 0.022 | 0.016 |
| CP3b | / | / | / | 0.269 | 0.256 | 0.018 | 0.301 | 0.280 | 0.016 |

In summary, the optical imaging lens assembly in Embodiment 1 to Embodiment 9 satisfy the relationships shown in Table 9.

TABLE 9

| Conditional | embodiment | | | | | | | | |
|---|---|---|---|---|---|---|---|---|---|
| expression | 1 | 2 | 3 | 4 | 5 | 6 | 7 | 8 | 9 |
| EP45/T45 | 4.0140 | 4.0383 | 1.7576 | 4.2404 | 4.3877 | 2.2869 | 3.6653 | 4.0563 | 3.5743 |
| d5m/f6*N6 | −2.1774 | −2.1932 | −2.1869 | −2.6168 | −2.6225 | −2.6225 | −1.9329 | −1.9399 | −1.9399 |
| T56/T45 | 3.8913 | 3.8913 | 3.8913 | 4.3395 | 4.3395 | 4.3395 | 6.7204 | 6.7204 | 6.7204 |
| f5/(D5s − d5s) | 2.1437 | 2.0313 | 2.3239 | 1.8997 | 1.7822 | 1.6722 | 2.5046 | 2.7011 | 2.3639 |
| (D5m − d5m)/T56 | 2.2584 | 2.3835 | 2.0834 | 2.5474 | 2.7153 | 2.3581 | 2.0462 | 1.8974 | 2.1680 |
| R9/d4m + R10/d5s | −2.5688 | −2.5420 | −2.6860 | −0.7182 | −0.7101 | −0.8578 | −10.2190 | −10.1744 | −10.1850 |
| T12/CP1 | 2.3577 | 1.9290 | 3.5365 | 3.7885 | 3.0997 | 4.2620 | 3.1069 | 2.5420 | 3.4953 |
| (D0m − d0s)/EPD | 1.1559 | 1.1559 | 1.1058 | 1.1022 | 1.1495 | 1.0520 | 1.1493 | 1.1307 | 1.1434 |
| CT2/(EP01 − CT1) | 1.9630 | 2.1940 | 2.0798 | 1.8413 | 2.3541 | 2.8370 | 1.7644 | 1.8541 | 1.7249 |
| f12/(D1m − d2s) | 2.6875 | 2.4643 | 2.9464 | 2.2291 | 2.0519 | 2.4375 | 2.3370 | 2.5679 | 2.1475 |
| CT2/EP12 | 1.7987 | 1.7426 | 1.7815 | 1.2627 | 1.2222 | 1.3061 | 1.1042 | 1.1874 | 1.1480 |
| EP23/T34 | 1.3291 | 1.3371 | 1.3491 | 1.0284 | 1.0197 | 1.0610 | 1.4138 | 1.5133 | 1.3765 |
| CT2/CT3 | 3.1319 | 3.1319 | 3.1319 | 1.7447 | 1.7447 | 1.7447 | 2.8945 | 2.8945 | 2.8945 |
| f2/D2s | 3.0327 | 2.9435 | 3.1274 | 1.1671 | 1.1318 | 1.2048 | 1.2436 | 1.2801 | 1.2090 |
| f3/d3s | −2.5603 | −2.5334 | −2.5011 | −1.9492 | −1.9235 | −1.6626 | −2.3810 | −2.3443 | −1.7674 |
| T23/CP2 | 1.5210 | 1.2444 | 2.2815 | 2.1165 | 1.7317 | 2.3811 | 0.4920 | 0.4025 | 0.5535 |
| R3/R4 | −2.4316 | −2.4316 | −2.4316 | −0.0280 | −0.0280 | −0.0280 | −2.1966 | −2.1966 | −2.1966 |
| R5/R6 | 1.5113 | 1.5113 | 1.5113 | 1.8432 | 1.8432 | 1.8432 | 1.6218 | 1.6218 | 1.6218 |
| (T34 + CT4)/EP34 | 2.5715 | 2.8061 | 2.7969 | 1.9368 | 2.1685 | 3.6904 | 1.5426 | 1.6953 | 2.8256 |
| SAG61/(CP5 + T56) | −1.0610 | −1.0546 | −1.0642 | −1.2642 | −1.2555 | −1.2686 | −0.9016 | −0.8968 | −0.9039 |
| (CP3b + CP3)/T34 | 0.0361 | 0.0442 | 0.0321 | 0.6227 | 0.5815 | 0.6010 | 0.6612 | 0.6136 | 0.6612 |

The disclosure further provides an electronic device, wherein the electronic device is equipped with the optical imaging lens assembly described above. The electronic device may be a wearable device such as a VR helmet, a smart watch, smart glasses, and the like, and may be an independent imaging device such as a digital camera, and may also be a mobile electronic device such as a mobile phone.

The above description is only illustration of preferred embodiments of the disclosure and applied technical principles. It should be understood by those skilled in the art that the invention scope involved in the disclosure is not limited to technical solutions formed by specific combinations of the above technical features, and should also cover other technical solutions formed by any combination of the above technical features or equivalent features thereof without departing from the inventive concept, for example, technical solutions formed by replacing the above features with technical features having similar functions disclosed in the disclosure (but not limited to).

What is claimed is:

1. An optical imaging lens assembly, comprising:
a lens group, sequentially comprising, from an object side to an image side along an optical axis: a first lens having a positive refractive power, a second lens having a positive refractive power, a third lens having a negative refractive power, a fourth lens having a positive refractive power, a fifth lens having a positive refractive power, and a sixth lens having a negative refractive power;
a support member group, comprising a fourth support member and a fifth support member, wherein the fourth support member is disposed between the fourth lens and the fifth lens and is in contact with an image-side surface of the fourth lens, and the fifth support member is disposed between the fifth lens and the sixth lens and is in contact with an image-side surface of the fifth lens; and
a lens barrel for accommodating the lens group and the support member group;
the optical imaging lens assembly satisfies:
$$3.8 < T 56 / T 45 < 6.8 ;$$
$$1.7 < EP 45 / T 45 < 4.5 ; and$$
$$1.6 < f 5 / ( D 5 s - d 5 s ) < 2.8 ;$$
wherein T45 is a spacing distance between the fourth lens and the fifth lens on the optical axis, T56 is a spacing distance between the fifth lens and the sixth lens on the optical axis, EP45 is a distance between the fourth support member and the fifth support member on the optical axis, f5 is an effective focal length of the fifth lens, D5s is an outer diameter of an object-side surface of the fifth support member, and d5s is an inner diameter of the object-side surface of the fifth support member.

2. The optical imaging lens assembly according to claim 1, wherein the spacing distance between the fifth lens and the sixth lens on the optical axis is greater than a spacing distance between any two adjacent lenses among the first lens to the fifth lens on the optical axis; and
an outer diameter D5m of an image-side surface of the fifth support member, an inner diameter d5m of the image-side surface of the fifth support member, and the spacing distance T56 between the fifth lens and the sixth lens on the optical axis satisfy: 1.8<(D5m−d5m)/T56<2.8.

3. The optical imaging lens assembly according to claim 1, wherein the inner diameter d5m of the image-side surface of the fifth support member, an effective focal length f6 of the sixth lens, and a refractive index N6 of the sixth lens satisfy: −2.7<d5m/f6*N6<−1.8.

4. The optical imaging lens assembly according to claim 1, wherein an inner diameter d4m of an image-side surface of the fourth support member, the inner diameter d5s of the object-side surface of the fifth support member, a radius of curvature R9 of an object-side surface of the fifth lens, and a radius of curvature R10 of the image-side surface of the fifth lens satisfy: −10.3<R9/d4m +R10/d5s<−0.6.

5. The optical imaging lens assembly according to claim 1, wherein a maximum thickness CP5 of the fifth support member, the spacing distance T56 between the fifth lens and the sixth lens on the optical axis, and a distance SAG61 from an intersection point of an object-side surface of the sixth lens and the optical axis to an effective radius vertex of the object-side surface of the sixth lens on the optical axis satisfy: −1.3<SAG61/(CP5+T56)<−0.7.

6. The optical imaging lens assembly according to claim 1, wherein an entrance pupil diameter EPD of the optical imaging lens assembly, an inner diameter d0s of an object-side end surface of the lens barrel, and an outer diameter D0m of an image-side end surface of the lens barrel satisfy: 0.95<(D0m−d0s)/EPD<1.2.

7. The optical imaging lens assembly according to claim 1, wherein the support member group further comprises a first support member, and the first support member is disposed between the first lens and the second lens and is in contact with an image-side surface of the first lens; and
a spacing distance T12 between the first lens and the second lens on the optical axis and a maximum thickness CP1 of the first support member satisfy: 1.85<T12/CP1<4.4.

8. The optical imaging lens assembly according to claim 1, wherein the support member group further comprises a first support member, and the first support member is disposed between the first lens and the second lens and is in contact with an image-side surface of the first lens; and
a center thickness CT1 of the first lens on the optical axis, a center thickness CT2 of the second lens on the optical axis, and a distance EP01 between an object-side end surface of the lens barrel and an object-side surface of the first support member on the optical axis satisfy: 1.6<CT2/(EP01-CT1)<2.9.

9. The optical imaging lens assembly according to claim 1, wherein the support member group further comprises a second support member, and the second support member is disposed between the second lens and the third lens and is in contact with an image-side surface of the second lens;
a radius of curvature R3 of an object-side surface of the second lens and a radius of curvature R4 of the image-side surface of the second lens satisfy: −2.6<R3/R4<0;
a radius of curvature R5 of an object-side surface of the third lens and a radius of curvature R6 of an image-side surface of the third lens satisfy: 1.4<R5/R6<1.9; and
a spacing distance T23 between the second lens and the third lens on the optical axis and a maximum thickness CP2 of the second support member satisfy: 0.3<T23/CP2<2.5.

10. The optical imaging lens assembly according to claim 1, wherein the support member group further comprises a first support member and a second support member, the first support member is disposed between the first lens and the second lens and is in contact with an image-side surface of the first lens, and the second support member is disposed between the second lens and the third lens and is in contact with an image-side surface of the second lens; and
a combined focal length f12 of the first lens and the second lens, an outer diameter D1m of an image-side surface of the first support member, and an inner diameter d2s of an object-side surface of the second support member satisfy: 1.9<f12/(D1m−d2s)<3.0.

11. The optical imaging lens assembly according to claim 1, wherein the support member group further comprises a first support member and a second support member, the first support member is disposed between the first lens and the second lens and is in contact with an image-side surface of the first lens, and the second support member is disposed between the second lens and the third lens and is in contact with an image-side surface of the second lens; and
a center thickness CT2 of the second lens on the optical axis and a distance EP12 between the first support member and the second support member on the optical axis satisfy: 1<CT2/EP12<1.9.

12. The optical imaging lens assembly according to claim 1, wherein the support member group further comprises a third support member, and the third support member is disposed between the third lens and the fourth lens and is in contact with an image-side surface of the third lens; and
a spacing distance T34 between the third lens and the fourth lens on the optical axis, a center thickness CT4 of the fourth lens on the optical axis, and a distance EP34 between the third support member and the fourth support member on the optical axis satisfy: 1.5<(T34+CT4)/EP34<3.8.

13. The optical imaging lens assembly according to claim 1, wherein the support member group further comprises a second support member and a third support member, the second support member is disposed between the second lens and the third lens and is in contact with an image-side surface of the second lens, and the third support member is disposed between the third lens and the fourth lens and is in contact with an image-side surface of the third lens;
a center thickness CT2 of the second lens on the optical axis and a center thickness CT3 of the third lens on the optical axis satisfy: 1.7<CT2/CT3<3.2; and
a distance EP23 between the second support member and the third support member on the optical axis and a spacing distance T34 between the third lens and the fourth lens on the optical axis satisfy: 0.9<EP23/T34<1.6.

14. The optical imaging lens assembly according to claim 1, wherein the support member group further comprises a second support member and a third support member, and the second support member is disposed between the second lens and the third lens and is in contact with an image-side surface of the second lens, and the third support member is disposed between the third lens and the fourth lens and is in contact with an image-side surface of the third lens;
an effective focal length f2 of the second lens and an outer diameter D2s of an object-side surface of the second support member satisfy: 1.0<f2/D2s<3.2; and
an effective focal length f3 of the third lens and an inner diameter d3s of an object-side surface of the third support member satisfy: −2.6<f3/d3s<−1.5.

15. The optical imaging lens assembly according to claim 1, wherein the support member group further comprises a third support member and a third auxiliary support member, the third support member is disposed between the third lens and the fourth lens and is in contact with an image-side surface of the third lens, and the third auxiliary support member is disposed on an image-side surface of the third support member and is in contact with the image-side surface of the third support member; and
the spacing distance T34 between the third lens and the fourth lens on the optical axis, a maximum thickness CP3 of the third support member, and a maximum thickness CP3b of the third auxiliary support member satisfy: 0<(CP3b+CP3)/T34<0.7.

16. The optical imaging lens assembly according to claim 1, wherein the support member group further comprises a fourth auxiliary support member, and the fourth auxiliary support member is disposed on an image-side surface of the fourth support member and is in contact with the image-side surface of the fourth support member,.
